(19) United States
(12) Patent Application Publication
(10) Pub. No.: US 2025/0348398 A1
(43) Pub. Date: Nov. 13, 2025

(54) RATE CONTROL ORCHESTRATING MULTIPLE DATA COLLECTION RATES ON A COMMON COMMUNICATION CHANNEL

(71) Applicant: HEWLETT PACKARD ENTERPRISE DEVELOPMENT LP, Spring, TX (US)

(72) Inventors: Sean Byland, Spring, TX (US); Steven James Martin, Plano, TX (US)

(21) Appl. No.: 19/007,952

(22) Filed: Jan. 2, 2025

Related U.S. Application Data
(60) Provisional application No. 63/644,343, filed on May 8, 2024.

(51) Int. Cl. G06F 11/30; G06F 11/34

(52) U.S. Cl. CPC G06F 11/3058; G06F 11/3065; G06F 11/3409

(57) ABSTRACT

Systems and methods are provided for rate control schemes for sampling sensors on a shared communication channel by grouping sensors into rate groups according to data collection rates. Examples include a communication channel, a plurality of sensors connected to the communication channel and configured to generate telemetry data, and a scheduler circuit configured to activate the communication channel according to a system rate. The scheduler circuit may sample telemetry data generated by the plurality of sensors according to a plurality of data collection rate groups, which include a subset of the plurality of sensors associated with a distinct data collection rate. The distinct data collection rates may be ratios of a system rate selected such that inverses of the ratios are whole numbers. Examples also include an integrated circuit configured to write the sampled telemetry data into a buffer. A system can be adapted based on the sampled telemetry data.

### CROSS REFERENCE TO RELATED APPLICATIONS

This application claims the benefit of and priority to U.S. Provisional Patent Application No. 63/644,343, filed on May 8, 2024, the contents of which are incorporated herein by reference in their entirety.

### BACKGROUND

Modern computing systems typically have multiple devices or components, such as multiple central processing units (CPU), multiple graphics processing units (GPUs), multiple memories, multiple accelerators, and the like. Each device may have its own respective sensors used for both run-time operations, such as health and/or performance monitoring, and validating board designs and triaging failures. These devices are connected to communication resources, such as communication bus, for reading data generated by the sensors. To minimize tying up computation resources, groups of sensors tend to share communication resources.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIGS. 1A and 1B are schematic diagrams of a computer system in which various examples of rate control presented herein may be implemented.

FIG. 2 illustrates an example configuration file for implementing rate control in accordance with examples disclosed herein.

FIG. 3 illustrates an example process for setting rate groups, in accordance with an example implementation of the present disclosure.

FIG. 4 illustrates an example process for initializing rate control in accordance with an example implementation of the present disclosure.

FIG. 5 illustrates an example sub-process of the process shown in FIG. 4, in accordance with an example implementation of the present disclosure.

FIG. 6 illustrates an example process for executing rate control in accordance with an example implementation of the present disclosure.

FIG. 7 depicts an example architecture and process flow for executing rate control run time, in accordance with an example implementation.

FIG. 8 is an example computing component that may be used to implement various features of rate control in accordance with the implementations disclosed herein.

FIG. 9 is an example of another computing component that may be used to implement various features of rate control in accordance with the implementations disclosed herein.

FIG. 10 is a computing component that may be used to implement examples of the disclosed technology.

The figures are not exhaustive and do not limit the present disclosure to the precise form disclosed.

### DETAILED DESCRIPTION

Examples of the present disclosure provide rate control schemes for sampling telemetry data from a plurality of sensors that share common communication channels by grouping sensors into rate groups according to data collection rates associated with the plurality of sensors. In examples, a computer resource, such as a blade server or the like, can comprise a plurality of telemetry sensors configured to generate telemetry data, or indications, which represent conditions relating to an environment and/or health of the computer resource. The plurality of telemetry sensors can be communicably connected to one or more communication channels, or buses. For example, subsets of the plurality of telemetry sensors may be communicably connected to ones of the communication channels (e.g., a first one or more sensors can be connected to a first common communication channel and a second one or more sensors can be connected a second common communication channel). Examples herein may define a plurality of rate groups, each of which can be associated with a different (e.g., distinct) data collection rate. The plurality of telemetry sensors can be grouped into the plurality of rate groups according to data collection rates at which the respective telemetry sensors are to be sampled. In various examples, the data collection rates can be set at ratios of a system rate and selected such that inverses of the ratios are whole numbers. The system rate may be a global rate at which the compute resource may attempt to read telemetry data by sampling the one or more communication channels. In examples, the communication channels can be activated (e.g., sampled) according to the system rate, and the plurality of telemetry sensors can be read according to the plurality of rate groups. As such, telemetry data can be obtained from the plurality of telemetry sensors according to the plurality of rate groups.

As noted above, modern computing systems typically have multiple devices or components. Each device may have its own respective telemetry sensors used for run-time operations, such as health and/or performance monitoring, and validating board designs and triaging failures. The computing systems may require numerous upstream support devices and may be constructed of sub-devices, all of which may have sensors generating telemetry data that may be sampled and reported for optimal device operation. To minimize physical hardware work (e.g., data transmissions over communication channels) and software work (e.g. threads of execution and development), groups of telemetry sensors tend to share communication resources. Furthermore, requirements on the computation resources may not necessitate that a given sensor is available 100% of the time. Thus, reading telemetry sensors over shared communication resources may require serializing communications. However, data collection rates can vary per-sensor and per-use-case, leading to many different rate (or frequency) requirements that can be challenging to support. For example, if the telemetry sensors are sampled at arbitrary data collection rates, some reads may conflict with each other and result in nondeterministic behavior, such as missed timing, data corruption, return of stale data, etc.

Some conventional approaches have attempted to address the above shortcomings. However, such approaches may not be able to handle all the data collection rates that may be required for optimal data reads, such as high-speed and low-speed data rates. For example, some conventional approaches trigger data reads at low speeds by utilizing a modulus operation to determine if a read can be performed. However, in these cases, high-speed data collection rates may not be implemented using this logic. For example, the pattern that the low-speed data collection rates follow for timing signals every thread for every tick, waking, and calculation to determine if it is time to sample. Oftentimes, these calculations derive that there is nothing to do, which functionally means that the total number of these calculations—which can be computationally expensive—are directly proportional to the number of buses, number of rate groups and the system tick rate. Thus, conventional approaches steered away from implementing high-speed data collection rates using the above logic to avoid restricting and causing performance regression in the low-speed data collection rates. Instead, the high-speed data collection rates have been implemented by manually constructing a query and inserting the query during a sleep period of the communication channel. To provide a desired rate, the sleep period may be tuned by hand until the sleep rate approximates the target rate (e.g., the inverse of the period).

Implementing high-speed rates in this way may lead to various difficulties. For example, control logic (e.g., logic constructed to control the data collection rates) may need to be re-written on a recurring basis to address any changes in target rates and system operations. Furthermore, a superfluous sub-system may be required to aggregate sampled data across the various data collection rates. For example, data sampled at the low-speed rate according to the modulus operation may have to be aggregated with data sampled according to the sleep period-based approach. Synchronization may also be degraded or lost between the different implementations, leading to lower quality data or invalid comparisons that may go undetected.

Further still, the above-discussed conventional approaches may be incompatible with field programmable gate array (FPGA) offloading. If an FPGA is configured for offloading of telemetry readings for one implementation (e.g., the modulus operation approach) then a query from a different implementation (e.g., the sleep period-based approach) may necessitate flushing the FPGA buffer and reloading. This can lead to the FPGA having to handle many operations at different layers of software, overall low sampling rates, increased power consumption, and potentially resource starvation, all of which can translate to a degraded user experience.

The technology of the present disclosure overcomes the above shortcomings by grouping telemetry sensors that share common communication channels into rate groups. Telemetry sensors may be grouped into distinct rate groups, each of which may be associated with a distinct data collection rate. Telemetry data can be collected according to the rate groups by signaling data collections (e.g., sampling of telemetry data reads) from telemetry sensors constituting to a respective rate group according to a respective data collection rate. While some examples herein are described with reference to a single communication channel, the disclosure can be extended to a plurality of communication channels, each of which can be connected to a respective subset of telemetry sensors.

The rate groups can be formed such that telemetry sensors associated with data collection rates are within one binary order of magnitude. That is, for example, the telemetry sensors of a given group will each be associated with a data collection rate that is within one binary order of magnitude of all other data collection rates within the given group. Additionally, data collection rates can be selected so that an inverse of a ratio of the data collection rate with respect to the system rate is a whole number. This constraint may assist to keep rate group periods (e.g., inverse of the data collection rates) uniform. Furthermore, the data collection rates of each rate group can encapsulate (e.g., is synchronized with) faster data collection rates of other rate groups. That is, for example, during sampling of a communication channel, a low-speed data collection rate can encapsulate faster data collection rates, such that sampling of telemetry sensors corresponding to the faster rate groups can be synchronized with sampling of telemetry sensors corresponding to the lower data collection rate group.

In examples, the system rate may be set globally for the computer resource. In examples, the system rate may be a system-wide global rate provided as a value for a desired number of times per second that communication channels can be activated for potentially sampling telemetry readings. In some examples, the system rate may be a user-provided value provided via a user interface. The inverse of the system rate may define a tick. A tick refers to the smallest unit of time between potential reads of the telemetry sensors. That is, each tick represents an instance at which the computer resource may decide whether or not to sample the communication bus to potentially read connected telemetry sensors.

In examples, a data collection rate may be a number of times per second that telemetry sensors of an associated rate group are to be read. Thus, while the system rate may define when communication channels can be activated for sampling to potentially read telemetry data, the data collection rates may define the instances at which telemetry sensors associated with a respective data collection rate (and those encapsulated therewith) are to be read to obtain telemetry data.

As an illustrative example, a first data collection rate (e.g., low-speed data collection rate) may be 1 Hz (e.g., 1 sample per second), a second data collection rate (e.g., an intermediate-speed data collection rate) may be 10 Hz, and a third data collection rate (e.g., a high-speed data collection rate) may be 100 Hz. The system rate, for illustrative purposes may be set to 100 Hz, but other system rates may be possible as desired in accordance with the present disclosure. In this example, the system rate translates to 100 ticks (e.g., sampling events) per second (e.g., one tick every 0.01 seconds). At each tick, the computer resource may activate the communication channel for potential reads. Yet, actual readings can only be obtained according to the data collection rates. For example, telemetry sensors making up the high speed data collection rate group may be sampled 100 times a second (e.g., every tick), telemetry sensors making up the intermediate speed data collection rate group may be sampled 10 times a second (e.g., every 10 ticks), and telemetry sensors making up the low speed data collection rate group may be sampled one time a second (e.g., every 100 ticks). Due to the encapsulation as noted above, anytime telemetry sensors associated with the first data collection rate (e.g., low-speed data collection rate) can be sampled and telemetry sensors associated with the second and third data collection rates can also be sampled (e.g., synchronized) because the first data collection rate encapsulates the second and third data collection rates. Similarly, any time telemetry sensors associated with the second data collection rate are sampled, the sensors associated with the third data collection rates can also be sampled.

Through the above techniques, contentions between samplings can be avoided. For example, contentions can be avoided by having a unified collection algorithm for all the rate groups, rather than having separate algorithms doing each collection that need to be synchronized. By encapsulating faster rate groups within slower rate groups, a single data collection can obtain telemetry data for each rate group encapsulated therein. The telemetry data can then be distributed to different devices and/or applications seeking the telemetry data. Because different devices and/or applications are not attempting to directly query a bus, concurrent device/application bus queries—which can cause failure due to the bus being busy doing a query—cannot happen. Conventionally, to avoid such contentions, a wait time may be implemented. However, by encapsulating the rate groups as disclosed herein, a wait time is not needed to avoid contentious simultaneous queries.

In examples, once data collection rates are set, the data collection rates and corresponding groups can be initialized to generate a tick-stream for the computer resource. A tick-stream may be a data structure that comprises a serialized cyclic sequence of all ticks for a period of the system rate. Each tick in the tick-stream can be associated with each of the one or more communication channels that are to be activated at the respective tick and each data collection rate group that is to be sampled on the activated one or more communication channels. This tick-stream can be stored into a device interface library (DIL) held in memory. Additionally, during initialization, a batch query can be constructed, sorted, and loaded into the same or different memory.

After initialization, a scheduler can request an activation-notification according to the system rate (e.g., an activation notification at each tick). Upon receiving a response to the request, the scheduler can start a sampling period and reference the DIL to obtain the tick-stream to identify which communication channels (if any) are to be sampled and which data collection rate groups (if any) are to be read for a given tick. Each communication channel may be assigned to a worker module, and the scheduler signals the worker(s) associated with the communication channels that are sampled for a given tick (if any). For each communication channel sampled for a given tick, the respective worker module activates its respective communication bus according to a bus rate, which may be a rate associated with that particular communication bus and synchronized therewith (e.g., an inverse of the ratio of the bus rate with the system rate is a whole number). The bus rate may be equal to or slower than the system rate, depending on the desired implementation. The worker module determines the subset of telemetry sensors associated with and encapsulated by any data collection rate groups to be read for the given tick and instructs the computer resource to execute sampling of the communication channel and reading telemetry data from determined telemetry sensors. For example, the worker module may iterate over the subset of telemetry sensors to obtain telemetry data therefrom. Thereafter, the worker module signals the scheduler that the telemetry data has been queried, and the scheduler iterates to the next tick in the tick-stream, whereby the above process can be repeated for the next tick.

Examples disclosed herein through the above example process can provide for improvements in computation resource utilization (e.g., processing resources, memory resources, and the like) through reduced processing and memory consumption. For example, as noted above, conventional approaches utilize modulus operations to determine if a read can be performed or not. The conventional approaches perform this modulus operation for each tick, thus possibly requiring numerous modulus operations, which can increase as the complexity of the rate groups increases. These operations can be taxing on processing and memory resources, which causes further latency. Examples herein can overcome this shortcoming, for example, by performing modulus operations during initialization to construct the tick-stream. By defining the rate groups according to the examples herein, the tick-stream for each system period (e.g., the inverse of the system rate) may be identical. Thus, the tick-stream can be loaded during initialization and executed by referencing data structure. Numerous and repetitive modulus operations can be avoided, thereby reducing processing and memory consumption and freeing up computation resource of other tasks.

It should be noted that the terms “optimize,” “optimal,” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances or making or achieving performance better than that which can be achieved with other settings or parameters.

As used herein, “rate control” may be a term used to describe input definitions or extrapolated outputs and the logic to set up and execute sampling of telemetry data.

As used herein, “frequency ratio” or “rate ratio” may refer to a decimal scalar that, when applied to a target data collection rate, can be used to calculate an effective data collection rate. In some examples, the rate ratio can be a decimal greater than zero but less than or equal to one. In some examples, the rate ratio can be represented as a percent by multiplying the decimal by one hundred and appending a ‘%’ character. Rate ratios can be input by a user via a user interface and can be defined relative to the system rate, bus rate, or an adjacent data collection rate group (e.g., a proceeding lower data collection rate group). For example, a user may input a rate ratio of 0.1 for a data collection rate group, which may be 0.1 (or 10%) of the system rate. If the system rate is 100 Hz, rate ratio of 0.1 represents a target data collection rate of 10 Hz. This configuration allows for simplicity in input target frequencies through a ratio, as opposed to a need to compute frequencies for telemetry sensors that are compatible with the system rate. During initialization, in some examples, the rate ratio may be converted into an absolute ratio.

As used herein, “effective data collection frequency” or “effective data collection rate” may refer to a derived value indicating a number of telemetry readings obtained from a given sensor per second. The effective data collection frequency, in some examples, may not be adjustable and may be an output characteristic derived from an aggregate of target frequencies defining a rate group. The effective data collection frequency or effective data collection rate may also be referred to as the data collection rate.

As used herein, “target data collection frequency” or “target data collection rate” may refer to a frequency that a user desires for sampling telemetry data from a particular sensor, which is derived from the rate ratio. Unlike the effective data collection frequency, the rate ratios may still need to be derived and input by the user. The examples herein can then derive target frequencies from the inputs. In some cases, a target data collection rate may not be mathematically possible, and the examples herein may derive an effective sensing frequency from the target data collection rate.

As noted above, a “tick” may refer to a potential read event of telemetry sensors. A set of ticks may be used to refer to a set of events, separated by the smallest unit of time between subsequent potential reads that may occur during a single system period, which is the inverse of the system rate.

As used herein, “loop scalar” may refer to an inverse of the rate ratio. In examples, the loop scalar may be a whole number and can be used as a modulus-scalar applied to an incrementing tick counter that can be used to derive a tick-stream for determining if telemetry reading should be sampled for a given tick.

As used herein, “system synchronization” may refer to a condition in which collection rate groups are common denominators of the system rate. This condition may mean that periodically there will be a tick at which every sensor on the computer resource can be sampled. Rate groups with the same data collection rate on different communication channels can be synchronized and therefore have data that is temporally comparable.

As used herein, “system synchronization period” may refer to a quantity of time for system synchronization (e.g., the condition during which every sensor on the system is sampled). It may be a common multiple of the slowest data collection rate.

As used herein, “communication channel”; “communication bus”; or “bus” may refer to a communication interface that provides access to any number of sensors or telemetry sensors. Different resources on a single communication channel may share access-related resources.

As used herein, “worker” or “worker module” may refer to a thread of execution dedicated to accessing sensors on a single communication channel. A “worker circuit” may refer to hardware or combination of hardware (e.g., processing and memory hardware) and software that embodies a worker module.

As used herein, “rate group” or “data collection rate group” may refer to a subset of sensors set to operate at a ratio of the effective data collection frequency used to enable multiple sensing frequencies on a given communication channel. A given data collection rate group definition may apply within a context of a communication channel, but because multiple communication channels may define identical or substantially similar rate groups, rate groups may be referenced without implying a specific communication channel. In examples, rate groups may be sorted from fastest rate to slowest rate. In some examples, each rate group's effective data collection frequency can be defined relative to a common reference point. In another example, a rate group's effective data collection frequency can be defined relative to that of the next fastest rate group to ensure that each rate group is a subset of the adjacent rate groups. In this way, it may not be possible to define incompatible rate groups.

As used herein, “tick-stream” may refer to a serialized cyclic sequence of events (e.g., ticks) that include, for each tick in a cycle, a number of communication channels (or workers) that are active for each tick. The ticks may be associated with a quantification of worker identifiers and rate-group tuples that, when sequentially read and acted upon, may result in telemetry data being scanned and published at effective frequencies.

As used herein, “scheduler”, “scheduler module”, or “schedule module” may refer to a thread of execution that, when activated based on a system rate, identifies which workers are to be active and which rate groups each active worker should process during a given tick. In examples, the scheduler signals any dormant workers to wake up and process a given rate group during a given tick. A “scheduler circuit” may refer to hardware or combination of hardware and software that embodies a scheduler or schedule module.

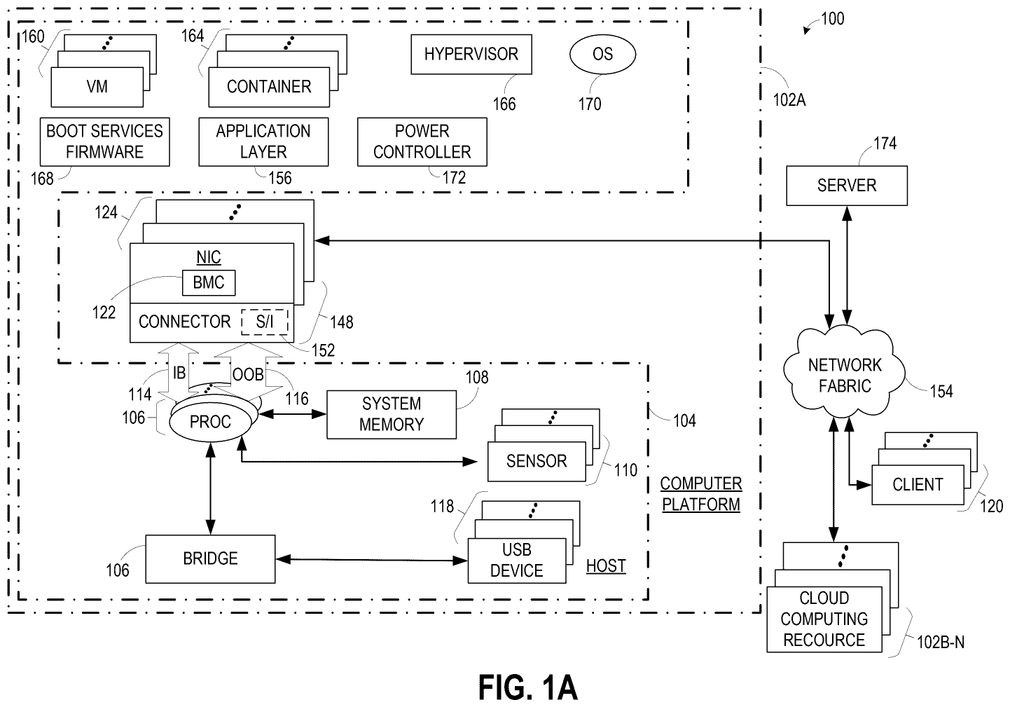

It may be useful to describe an example computer resource in which the examples disclosed herein might be implemented in various applications. FIG. 1A is a schematic diagram of a computer system 100 in which various of the examples presented herein may be implemented. The computer system 100 can be affiliated with a cloud operator that may provide multi-tenant cloud services for multiple clients, or tenants. The cloud services may be any of a number of different cloud services, such as Software as a Service (SaaS), Infrastructure as a Service (IaaS), Platform as a Service (PaaS), and so forth. Moreover, depending on the implementation, the cloud services may be affiliated with one of several different cloud infrastructures, such as a public cloud that is generally available to all potential users over a public network, a limited access private cloud that is provided over a private network (e.g., cloud services provided by an on-site data center), or a hybrid cloud that is a combination of public and private clouds.

The computer system 100 may comprise computer resources 102A-N (collectively referred to as computer resources 102) configured to provide cloud services. Clients may access computer resources 102 via one or more clients 120 (e.g., laptops, desktop computers, smartphones, tablet computers, wearable computers, and so forth). As depicted in FIG. 1A, the computer resources 102 and clients 120 may be interconnected by network 154. The network 154 may be associated with one or multiple types of communication networks, such as, but not limited to, Fiber Channel networks, Gen-Z fabrics, dedicated management networks, local area networks (LANs), wide area networks (WANs), global networks (e.g., the Internet), wireless networks, telecommunications networks, or any combination thereof, as some examples.

The computer resources 102 may be a shared pool of resources, including physical hardware resources, such as physical servers (e.g., server blades), networking components, administrative resources, physical storage devices, physical storage networks, and so forth. FIG. 1A illustrates an example physical computer resource 102A, which may provide at least part of the computer resources 102. In this context, a “computer resource” may refer to a unit including a chassis and hardware that can be mounted to the chassis, where the hardware may be capable of executing machine-executable instructions (e.g., “software”) stored in a memory. The computer resource 102A may be an example of a blade server, in accordance with an example implementation. However, in other examples, the computer resource 102A may be a platform other than a blade server, in accordance with other implementations, such as a rack-mounted server, a client, a desktop, a smartphone, a laptop computer, a tablet computer, and so forth.

For examples in which the computer resource 102A is implemented as a blade server, the server may have a frame or chassis. One or multiple motherboards may be mounted to the chassis and each motherboard may contain one or multiple multicore semiconductor packages (also referred to as “sockets” or “chips”). In accordance with example implementations, a blade server may have a form factor, mechanical latch(es) and corresponding electrical connectors for purposes of allowing the server blade to be installed in and removed from a corresponding server blade opening, or slot, in rack-mounted blade enclosure.

Regardless of the particular implementation, in accordance with the examples disclosed herein, the computer resource 102A may have a cloud native architecture in which hardware resources and machine-executable instruction resources (i.e., “software resources”) of the computer resource 102A can be divided into two security domains: a client domain and an operator domain. In this context, the “client domain” may refer to a part of the computer resource 102A associated with executing client software and data. In examples, the operator (e.g., the entity providing the services) may not access or at least has limited access to the client data and software. The “operator domain” may refer to the part of the computer resource 102A associated with providing input/output (I/O) services for the executing client software. In examples, the clients may not access or have limited access to data and software for managing operations of the computer resource 102A.

For example, as shown in the example of FIG. 1A, the computer resource 102A includes a host 104 that may be associated with the client domain. The host 104 may include an application layer 156, which may contain application instances associated with one or multiple clients at any particular time. Virtualization technology may be employed on the computer resource 102A for purposes of providing security and fault isolation among the clients. For example, application instances for a particular client may be executed inside one or multiple virtual machines (VMs) 160, and these VM(s) 160, in turn, may reside inside a given container 164 associated with the client. In this manner, in accordance with some implementations, a given client may be associated with one or multiple VMs 160 and one or multiple containers 164.

In this context, a “virtual machine,” or “VM” (also called a “guest virtual machine,” a “virtual machine instance,” or “a guest virtual machine instance”) may refer to a virtual environment that functions as a virtual server, or virtual computer system, which has its own physical resources (e.g., CPU(s), system memory, network interface(s) and storage). Moreover, the VM may have its own abstraction of an operating system, such as operating system 170, and in general, the VM is a virtual abstraction of hardware and software resources of the computer resource 102A. The lifecycle (e.g., the deployment and termination) of the VM may be managed by a virtual machine monitor (VMM), or hypervisor, such as hypervisor 166.

A “container” (also called an “instantiated container,” “container instance,” or “software container”), as used herein, may refer to a virtual run-time environment for one or multiple applications and/or application modules, and this virtual run-time environment is constructed to interface to an operating system kernel. A container for a given application may, for example, contain the executable code for the application and its dependencies, such as system tools, libraries, configuration files, executables and binaries for the application. In accordance with example implementations, the container may contain an operating system kernel mount interface but may not include the operating system kernel. As such, a given computer resource may, for example, contain multiple containers that share an operating system kernel through respective operating system kernel mount interfaces. Docker containers and rkt containers are examples of software containers.

In the example of FIG. 1A, the host 104 may include a bus infrastructure for connecting the host 104 to an operator domain, which includes one or multiple expansion bus connectors 148 (e.g., Peripheral Component Interconnect express (PCIe) bus connectors), a plurality of out-of-band (OOB) communication channels 116 (collectively referred to as OOB communication channels 116 and individually as an OOB communication channel 116), and a plurality of in-band (IB) communication channels 114. A given expansion bus connector 148 (sometimes referred to as “connector” 148) may receive a network interface card (NIC) 124. As depicted in FIG. 1A, in accordance with example implementations, a NIC 124 may include a baseboard management controller (BMC) 122. In examples, the BMC 122 may manage operations of the computer resource 102A, i.e., the BMC 122 may manage operations of the host 104 and the NIC 124.

As used herein, a “BMC,” or “baseboard management controller,” may be a specialized service processor that monitors the physical state of a server or other hardware using sensors and communicates with a management system through a management network. The BMC may also communicate with applications executing at the operating system-level through an I/O controller (IOCTL) interface driver, a representational state transfer (REST) application program interface (API), or some other system software proxy that facilitates communication between the BMC and applications. The BMC may have hardware level access to hardware devices that are located in a server chassis including system memory. The BMC may be able to directly modify the hardware devices. The BMC may operate independently of the operating system of the system in which the BMC is disposed. The BMC may be located on the motherboard or main circuit board of the server or other device to be monitored. The fact that a BMC is mounted on a motherboard of the managed server/hardware or otherwise connected or attached to the managed server/hardware does not prevent the BMC from being considered “separate” from the server/hardware. As used herein, a BMC has management capabilities for sub-systems of a computing device, and is separate from a processing resource that executes an operating system of a computing device. The BMC is separate from a processor, such as a central processing unit, which executes a high-level operating system or hypervisor on a system.

The BMC 122 may be remotely accessed by a remote management server 174 coupled to the network 154. In this manner, the remote server 174 may communicate requests (e.g., Intelligent Platform Management Interface (IPMI) messages containing IPMI commands) to the BMC 122 for the BMC 122 to manage and control functions of the host 104 and NIC 124. The remote server 174 may receive messages (e.g., IPMI messages) from the BMC 122 representing status information, health information, configuration information, configuration options, event notifications, and so forth) from the BMC 122.

In accordance with example implementations, the BMC 122 may manage the host 104 using communications that occur through a signaling interface 152 of the connector 148 via one or more of the OOB communication channels 116. The OOB communication channels 116 may communicably connect the host 104 to the operator domain. Client applications and software may not have access to OOB communication channels 116. In this context, the signaling interface 152 of the connector 148 may refer to physical communication terminals (e.g., pins, sockets, or terminals) of the connector 148. An “out-of-band communication channel” with the NIC 124, in this context, may refer to the use of a secure communication channel with the NIC 124 other than the NIC's primary communication channel. For example, in accordance with some implementations, the NIC 124 may be a Peripheral Component Interconnect express (PCIe) bus card, which has a primary PCIe bus communication channel. In this example, the OOB communication channel 116 may comprise one or more communication buses, for example but not limited to, one or more inter-integrated (I₂C) buses, one or more improved inter-integrated (I³C) buses, one or more Serial Peripheral Interface (SPI) buses, one or more enhanced SPI (eSPI) buses, one or more buses associated with another standard, or combinations thereof. The signaling interface 152 may include, in accordance with example implementations, communication channels that are associated with the communication of control and/or telemetry signals to/from the BMC 122. Depending on the particular implementation, the signaling interface 152 may correspond to all of the terminals of the connector 148 or may correspond to a lesser subset of all of the terminals of the connector 148.

The NIC 124 may, in accordance with example implementations, be disposed on a circuit card substrate that has a card edge connector constructed to be inserted into the connector 148 to mechanically secure the NIC 124 to the connector 148 and form electrical connections between the host and the NIC 124. For example, the connector 148 may be a slot connector and a circuit card substrate of the NIC 124 may have electrically conductive traces disposed on a card edge. The card edge may have a form factor constructed to be received inside the connector 148 so that when the card edge can be received in the connector. The traces may contact and electrically connect to terminals (e.g., spring terminals) of the connector 148.

In accordance with some implementations, the BMC 122 may include dedicated hardware configured to perform solely BMC-related management operations. In examples, the dedicated hardware may not be shared with other components of the NIC 124 for non-management-related BMC operations. For example, the BMC 122 may contain a main semiconductor package (or “chip”), which contains one or multiple semiconductor die. More specifically, in some examples, the BMC 122 may include a main semiconductor package that includes one or multiple main hardware processing cores (e.g., CPU cores, Advanced Reduced Instruction Set Computer (RISC) Machine (ARM) processing cores, and so forth), which execute machine-executable instructions (or “software,” such as firmware) for purposes of managing operations of the host 104 and the NIC 124.

In some examples, the BMC 122 may be a virtual BMC. That is, for example, the BMC 122 may be an abstraction of actual hardware and software of the NIC 124. For example, the NIC 124 may provide one or multiple guest VMs, which provides for the BMC 122. The guest VM(s) may, for example, be executed inside a virtualized environment, such as a container. In accordance with some implementations, the NIC 124 may contain, as further described herein, hardware processors (e.g., CPUs, CPU processing cores, ARM processing cores, and so forth), which execute machine-executable instructions for purposes of providing one or multiple I/O services for the NIC 124. In accordance with example implementations, one or multiple of these hardware processor(s) of the NIC 124 may further execute instructions to provide the VM(s) and BMC 122.

In accordance with some example implementations, the BMC 122 may be a hybrid combination of a virtual BMC and a hardware BMC. For example, the hybrid BMC 122 may contain dedicated hardware components to provide certain management and/or security functions of the hybrid BMC 122, while hardware processors of the NIC 124, which execute machine-executable instructions to provide I/O services for the NIC 124, may further execute machine-executable instructions to provide other management and/or security functions of the hybrid BMC 122.

The host 104, according to various examples, may include one or multiple general-purpose hardware processors 106 (e.g., one or multiple CPU packages, one or multiple CPU processing cores, one or multiple GPU cores, one or multiple FPGAs, and so forth), a system memory 108, and the bus infrastructure, as described above. In accordance with example implementations, the general-purpose hardware processor(s) 106 may execute machine-executable instructions (e.g., “software”) for the host 104. For example, the hardware processor(s) 102 may execute instructions associated with instances of the VMs 160, instances of the containers 164, a hypervisor 166, the operating system 170, application instances associated with the application layer 156, boot services firmware 168, and so forth. In accordance with example implementations, the system memory 108 and other memories that are discussed herein may be non-transitory storage media that may be formed, in general, from storage devices, such as semiconductor storage devices, memristor-based storage devices, magnetic storage devices, phase change memory devices, a combination of devices of one or more of these storage technologies, and so forth. The system memory 108 may represent a collection of both volatile memory devices and non-volatile memory devices. The boot services firmware 168 represents firmware (e.g., basic input/output operating system (BIOS) firmware and/or Unified Extensible Firmware Interface (UEFI) firmware) that can be executed by the computer resource 102A during the boot of the computer resource 102A after a power on or reset of the computer resource 102A.

In accordance with example implementations, the bus infrastructure of the host 104 may include one or multiple bridges 112 that may be coupled to the system memory 108, and other components of the host 104, such as, but not limited to, one or multiple USB devices 118, one or more sensors 110, and so forth. The bridge(s) 112 may include one or multiple PCIe ports that can be connected, via one or a plurality of IB communication channels 114 (e.g., corresponding PCIe links or the like), to one or multiple PCIe bus expansion cards 148, such as the depicted connector 148 that receives the NIC 124. The bridge(s) 106 may include interfaces to various buses of the host 104, such as a PCIe bus, an SPI bus, an enhanced SPI (eSPI) bus, a Low Pin Count (LPC) bus, an I²C bus, an I³C bus, as well as possibly buses associated with other bus standards.

In accordance with some implementations, the bridges 112 may include a north bridge and a separate south bridge. In this manner, in accordance with some implementations, the general-purpose hardware processor(s) 106 may include one or multiple semiconductor packages (or “chips”), and the general-purpose hardware processor(s) 106 may include the north bridge that includes a memory controller and PCIe root ports. The south bridge that may provide I/O ports, such as, for example, Serial Advanced Technology Attachment (SATA) ports, Universal Serial Bus (USB) ports, LPC ports, SPI ports, eSPI ports and so forth. In accordance with some implementations, the north bridge may not be part of the general-purpose hardware processor(s) 106. In accordance with further implementations, the north and south bridges may be combined into a single bridge 112; and in accordance with some implementations, this single bridge 112 may be part of the general-purpose hardware processor(s) 106.

Among its other hardware components, in accordance with example implementations, the host 104 may include a power controller 172, which may be controlled through the operating system 170 for purposes of setting a particular system power state for the computer resource 102A. In this manner, in accordance with example implementations, the operating system 170 may communicate with the power controller 172 (e.g., cause the assertion of one or multiple signals to the power controller 172) for purposes of changing the system power state. In this context, the “system power state” refers to the power state of all components of the computer resource 102A, except for components of the computer resource 102A that are involved in the platform's management, such as the BMC 122. For a given system power state, some components of the computer resource 102A may be powered up at different levels than other components (e.g., some components of the computer resource 102A may be powered down for a given power consumption state for purposes of conserving power, whereas other components may be powered up to a relatively higher power consumption state). For example, the operating system 170 may communicate with the power controller 172 for purposes of transitioning the computer resource 102A to a power on reset, transitioning the computer resource 102A from a higher power consumption state to a lower power consumption state, transitioning the computer resource 102A from a lower power consumption state to a higher power consumption state, powering down the computer resource 102A, and so forth.

In accordance with example implementations, the power controller 172 may be controlled by an entity other than the operating system 170. For example, in accordance with some implementations, the boot services firmware 168 may communicate with the power controller 172 for purposes of controlling the system power state. Moreover, as further described herein, in accordance with some implementations, the BMC 122 may communicate with the appropriate entity (e.g., the power controller 172, the boot services firmware 168 or operating system 170) for purposes of changing the system power state.

As also depicted in FIG. 1A, in accordance with some implementations, the computer resource 102A may include one or more sensors 110. Sensor 110 may include telemetry sensors in accordance with examples disclosed herein. For example, the sensors 110 may be configured to generate telemetry signals (e.g., signals encoded with telemetry data), or indications, which represent various sensed conditions relating to the environment and/or health of the computer resource 102A. The sensors 110 may provide the telemetry signals to the BMC 122. In this manner, in accordance with example implementations, the BMC 122 may monitor telemetry signals provided by sensors 110 for such purposes as monitoring the health of the computer resource 102A; monitoring temperatures of the computer resource 102A for purposes of performing thermal management; monitoring current, power, and/or voltage of the computer resources 100A for the purposes of performing power consumption management of the computer resource 102A; monitoring for tamper detection, and so forth. As examples, the sensors 110 may be temperature sensors, tamper indication sensors, overvoltage sensors, undervoltage sensors, fan speed sensors, current sensors, power sensors, humidity sensors, flow sensors, pressure sensors, counters (e.g., cache hits, cache misses, number of interrupts, and the like), and so forth. The signals that are generated by the sensors 110 can be routed to the BMC 122 by the general-purpose hardware processor(s) 106 through the OOB communication channels 116 via the signaling interface 152.

Referring to FIG. 1B, in accordance with an example implementation, the BMC 122 may include one or multiple hardware components that can be mounted to one or multiple circuit substrates 126. Moreover, a given circuit substrate 126 may have a form factor and corresponding features (electrical traces, and so forth), which allows the

BMC 122 connected to the connector 148. In accordance with example implementations, the BMC 122 may include hardware components, such as one or multiple hardware processors 128 (e.g., one or more integrated circuits, such as, but not limited to, FPGAS, CPU processing cores, such as ARM processing cores, embedded processing cores, ARM processing cores, and so forth); and a memory 132.

The processor(s) 128 may execute machine-executable instructions 134 stored in the memory 132. In accordance with some examples, the processor(s) 128 may execute the instructions 134 for purposes of performing one or multiple operator domain-based I/O services for the computer resource 102A. For example, the processor(s) 128 may execute the instructions 134 to perform telemetry I/O services by sampling telemetry signals generated by one or more of sensors 110 to obtain telemetry data representing sensed conditions relating to the environment and/or health of the computer resource 102A. In this manner, the BMC 122 can monitor the physical state of computer resource 102A using sensors 110 by signaling over the OOB communication channels 116.

In the example of FIG. 1B, the BMC 122 may monitor the computer resource 102A by sampling signals generated by subsets 110A-110N of sensors 110. Telemetry signals of each subset 110A-110N may be communicated through the signaling interface 152 of the connector 148 via ones of OOB communication channels 116A-116N. In the example of FIG. 1B, OOB communication channels 116 may comprise channels 116A-116N that collectively represent the OOB communication channels 116. As shown in the example of FIG. 1B, a first subset 110A of sensors 110 (e.g., one or more of sensors 110) may be communicably connected to a first channel 116A, a second subset 105B of sensors 110 may be communicably connected with a second channel 116B, and so on until an nth subset 105N of sensors 110, which may be communicably connected with an Nth channel 116N. Each OOB communication channel 116A-116N may be implemented as, for example but not limited to, an I²C bus, an I³C bus, a SPI buses, an eSPI bus, or other buses associated with another standard.

While FIG. 1B depicts three subsets of sensors 110 and three OOB communication channels 116, this is for illustrative purposes. Examples herein may comprise a single OOB communication bus communicably connected to a single subset of sensors, or any number of sets as desired for a given implementation.

Further, as shown in FIG. 1B, subset 110A of sensors 110 can be logically grouped into rate groups 176A-176N according to data collection rates associated with the sensors 110. For example, one or more sensor(s) 110A-1 of subset 110A may be associated with a first data collection rate, one or more sensor(s) 110A-2 of subset 110A may be associated with a second data collection rate, and one or more sensor(s) 110A-M of subset 110A may be associated with an Nth data collection rate. The one or more sensor(s) 110A-1 can thusly be grouped into a first data collection rate 176A, while the one or more 110 sensors 110A-2 and 110A-M can be grouped into a second data collection rate 176B and an Nth data collection rate 176M, respectively. The rate groups 176A-176M can be formed such that groups of sensors are sensors associated with data collection rates within one binary order of magnitude of all other data collection rates making up a given group.

The foregoing description is made with reference to subset 110A of sensors 110; however, other subsets of sensors 110 can be similarly grouped into rate groups. For example, ones of subset 110B of sensors 110 can be grouped into multiple rate groups, and ones of subset 110N can be grouped into multiple rate groups. In examples, to the extent that rate groups of different subsets on different OOB communication channels 116 correspond to the same data collection rate, the telemetry readings sampled from the corresponding sensors can be synchronized and therefore the readings may contain data that can be temporally comparable across the different OOB communication channels 116. For example, telemetry readings sampled on a first OOB communication channel 116 can be synchronized in time with telemetry readings sampled on one or more other OOB communications channels 116. This synchronization can facilitate comparing telemetry readings that correspond to a common point in time.

As an illustrative example, assume telemetry readings from one OOB communication channel 116 indicates system wide power consumption, while telemetry readings from another OOB communication channel may provide power consumption by a voltage regulator of the system. Since the telemetry readings are synchronized in time via sampling according to the rate groups, as described herein, one can assess the percentage of the total power consumption due to the voltage regulator. Whereas, without the synchronization achieved according to the present disclosures, the telemetry readings may not correspond to the same instance in time, and as such may not reflect an actual power consumption proportion of the total power consumption due to the voltage regulator, in the above example.

In examples, memory 132 may also comprise a buffer 144 or other temporary storage space. Examples here may temporarily store telemetry data (e.g., raw telemetry data) in the buffer 144, which can be read out of the buffer 144 for processing. Examples herein may process the telemetry to obtain, among other things, processed telemetry data and/or synthetic values derived from raw or processed telemetry data. Synthetic values may include key performance indicators (KPI) and other metrics that can be used to monitor the conditions relating to an environment and/or health of the computer resource 102A. Performance of the computer resource 102A may be adapted or changed based on the processed telemetry data and/or synthetic values, for example, in a manner that seeks to optimize computation resources or avoid dangerous conditions (e.g., running hot that could cause damage). Examples herein may shift client tasks to other computer resources 102B-N or other computation resources of computer resource 102A to optimize conditions. The processor(s) 128 may implement such adaptions based on the telemetry data stored into buffer 144.

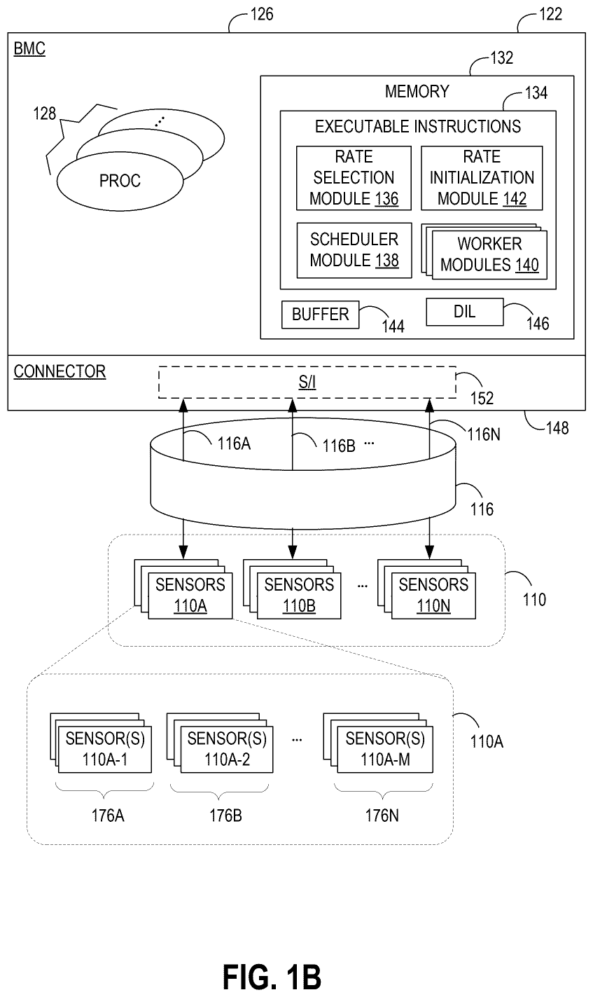

Memory 132 may store a device interface library (DIL) 149 that specifies information descriptive of OOB communication channels 116 and connected devices, each of which may comprise one or more of the sensors 110. FIG. 2 illustrates an example DIL 200, which can be implemented as DIL 146 in an illustrative example.

In this example, DIL 200 includes multiple hierarchical levels 202A-202C

of data tables. Each level may set forth communication channels (e.g., OOB communication channels 116) and connected devices, as well as connected telemetry sensors, in self-referencing data tables.

For example, a first level 202A comprises a system-level data table 204 that specifies each communication channel on a computer resource. Referring to FIG. 1A, the system-level data table 204 may specify each OOB communication channel 116 of computer resource 100A. In this example, four OOB communication channels are shown as row entries; however, any number of OOB communication channels may be included in system-level data table 204 depending on the implementation. Each channel can be associated with, among other information, communication channel identifiers (e.g., labels), channel number, a communication protocol (e.g., I²C, I³C, SPI, eSPI, or other protocol), identification of physical location (e.g., enclosure, node, etc.), parental context (e.g. a physical resource to which the communication channel is attributable, such as, but not limited to, chassis, accelerator, etc.), a bus scan rate ratio, a bus maxim publication rate ratio, and one or more rate group scan rate ratios. In the example of FIG. 2, the identification of physical location is provided according to a Redfish schema, as known in the art. However, other schemas may be used as desired for a given application.

Additionally, in the example of FIG. 2, the one or more rate group scan rate ratios comprise three rate groups ordered from a highest speed to a lowest speed data collection rate. In this example, the rate ratio is defined as a scan rate ratio of the preceding scan rate. That is, for example, the bus scan rate ratio may be provided as a ratio with respect to the system rate and may be equal to or slower than the system rate, depending on the desired implementation. The first rate group scan rate ratio (e.g., Gr. 1) may be provided as a ratio with respect to the bus scan rate ratio. The second rate group scan rate ratio (e.g., Gr. 2) may be provided as a ratio with respect to the first rate group scan rate ratio. This continues through the final rate group.

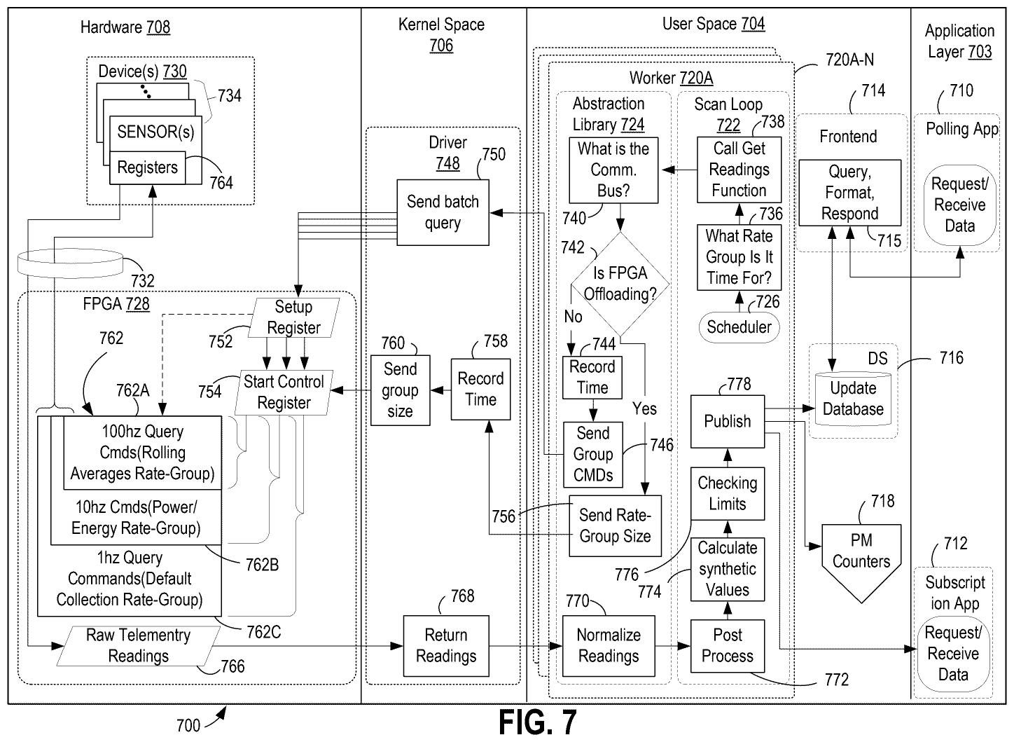

As noted above, system-level data table 204 includes publishing rates for the communication channels listed therein. The publishing rate (e.g., maximum bus publication rate ratio) may represent a maximum rate at which readings are published (e.g., delivered) to a storage device (e.g., a data storage platform, as described in connection with FIG. 7 below). Thus, while the scan rate ratios correspond to rates at which telemetry data is sampled (e.g., scanned), the publishing rate may represent a rate at which the telemetry data is recorded. As an example, a temperature sensor may be sampled every 10 ms (e.g., at a rate group associated with a data collection rate of 100 Hz), so that the system (e.g., the BMC 122) can respond to any under/over temperature conditions. But for historical data logging, one reading per second (e.g., 1 Hz) may be sufficient for time series analysis. However, if recording to a data storage is set to 100 hz, then 10× the storage as compared to 1 Hz may be required to publish telemetry data sampled at 100 Hz. As noted above, this resolution in the readings may not be needed. Thus, the publishing rate can be set as desired.

A second level 202B, in this example, comprises channel (or bus) level data tables 206A-206N (collectively referred to herein as channel (or bus) level data tables 206), one for each communication channel specified in the system-level data table 204. Each channel level data table 206 may specify each device connected to that particular communication channel. For example, bus level data table 206A shown in FIG. 2 may correspond to OOB communication channel 210 specified in the system-level data table 204. In this example, three connected devices are shown as row entries; however, any number of devices may be included in channel level data tables 206 depending on the implementation. Each device can be associated with, among other information, an index, a device identifier, a name, physical context (e.g., a device type of the device, such as but not limited to, processor, network interface card, voltage regulator—as in the example of FIG. 2, and the like), reference designator (refdes) (e.g., as part of an identifier given to each device and used to find the device in engineering schematics and/or drawings), device communication protocol, address, and board revisions, each of which can be sorted into respective columns. The devices may be, in some examples, ones of USB devices 118 from FIG. 1A.

A third level 202C, in this example, comprises device level data tables 208A-208N (collectively referred to herein as device level data tables 208), one for each device specified in the channel level data tables 206. Each device level data table 208 may specify each telemetry sensor comprised as part of or otherwise connected to a particular device. For example, each device may comprise one or more telemetry sensors, each of which can generate telemetry signals configured, or indications, that represent conditions sensed by the particular telemetry sensor. For example, device level data table 208A shown in FIG. 2 may correspond to the device 212 specified in the channel level data table 206A. In this example, three telemetry sensors are shown as row entries, each configured to sense a condition (e.g., telemetry sensor 214 that senses current is shown as an illustrative example); however, any number of telemetry sensors may be included in device level data tables 208 depending on the implementation. Each telemetry sensor can be associated with, among other information, a reading type, unit of the reading (e.g., sensed condition), a PhysicalSubContext (e.g., an identifier of where, within the device, the telemetry sensor reading applies and may be either “input” or “output”), a PmbusCommand (e.g., a standards-based command for sampling the telemetry sensor), loop, upper critical (e.g., an upper threshold for triggering an alert based on readings by the telemetry sensor indicating that the device is in dire need of action), and upper fatal (e.g., an upper threshold for triggering a device shut down to protect the device from failure), each of which can be sorted into respective columns. The sensors may be, in some examples, ones of sensors 110 from FIGS. 1A and 1B.

As noted above, the example of FIG. 2 is populated with values according to the Redfish schema, as known in the art. However, other schemas may be used as desired for a given application.

Returning to FIG. 1B, in examples the processor(s) 128 may execute the instructions 134 to sample telemetry signals representing sensed conditions relating to the environment and/or health of the computer resource 102A according to the rate groups 176A-176N. Rate groups 176A-176N may be formed in the DIL 146. For example, a data entry may be added to each row entry of the device level data tables 208 and this data entry may indicate which rate group is associated to which the telemetry sensor, as defined by the particular row entry. In examples, the rate group may be specified as rate ratio that defines a target data collection rate, which can be used to derive an effective data collection frequency. Thus, rate groups can be formed by grouping telemetry sensors that are within a binary order of magnitude of each other.

In the example of FIG. 1B, instructions 134 may comprise a rate selection module 136 containing instructions, that when executed by the processor(s) 128, may generate a configuration file by referencing DIL 146 to specify rate groups for each communication channel 116A-116N, specify data collection rate ratios for each sensor 110 on each communication channel 116A-116N, a loop scalar for each sensor 110 on each communication channel 116A-116N, and an effective data collection frequency for each sensor 110 on each communication channel 116A-116N. For example, OOB communication channels 116A-116N that are available for sampling telemetry data can be specified in DIL 146, along with connected sensors 110. The DIL 146 can specify channels to which telemetry sensors are connected (e.g., tables 202A-202C of FIG. 2). Target data collection rates for each sensor 110 can be provided to the rate selection module 136, along with a system rate for BMC 122. In an example, this information can be input by a user via a user interface. The target data collection rate, in some examples, can be supplied as a rate ratio of the target data collection rate with respect to the system frequency (e.g., target data collection rate divided by the system frequency provides the rate ratio). In some examples, the DIL 146 can be updated to include column entries of the rate ratio for each sensor.

The rate selection module 136, in some examples, may constrain the rate ratio such that the inverse of the rate ratio (e.g., the loop scalar) is a whole number. In this case, if the target data collection rate does not result in a loop scalar that is a whole number, an effective data collection frequency can be derived from the target data collection rate to satisfy these conditions.

Additionally, in some examples, a minimum rate may be provided for each sensor 110. The rate selection module 136 may use the minimum rate as a barrier such that any effective data collection rate derived from a target data collection rate cannot be less than the minimum rate.

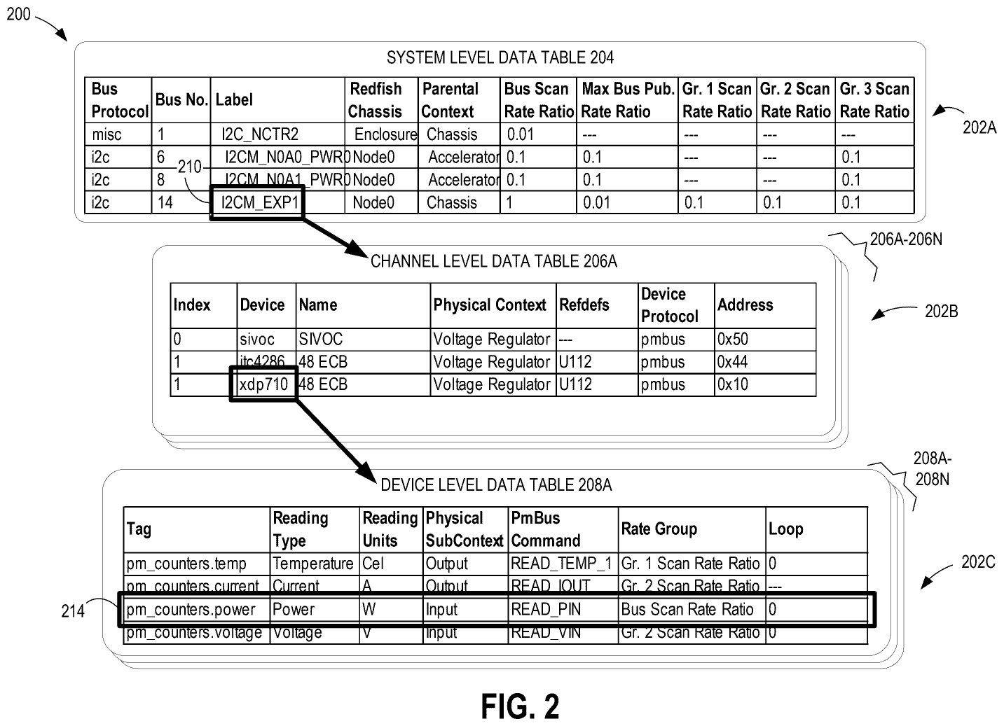

Once effective data collection rates are defined, in the form of rate ratios, the rate selection module 136 may use the effective data collection rates to form rate groups. For example, ones of sensors 110 connected to a given channel 116 can be grouped into rate groups such that the effective data collection rates associated with sensors of a given rate group are within one binary order of magnitude of each other. An example of this process is described below in connection with FIG. 3.

In the example of FIG. 1B, instructions 134 may also comprise a rate initialization module 142 containing instructions, that when executed by the processor(s) 128, may initialize a rate control logic in the BMC 122. For example, a batch query can be constructed for each for each OOB communication channel 116 as specified in the configuration file, which can be loaded into the processor(s) 128. A batch query may be a query object that includes information and commands for sampling each sensor 110 connected to a given OOB communication channel 116.

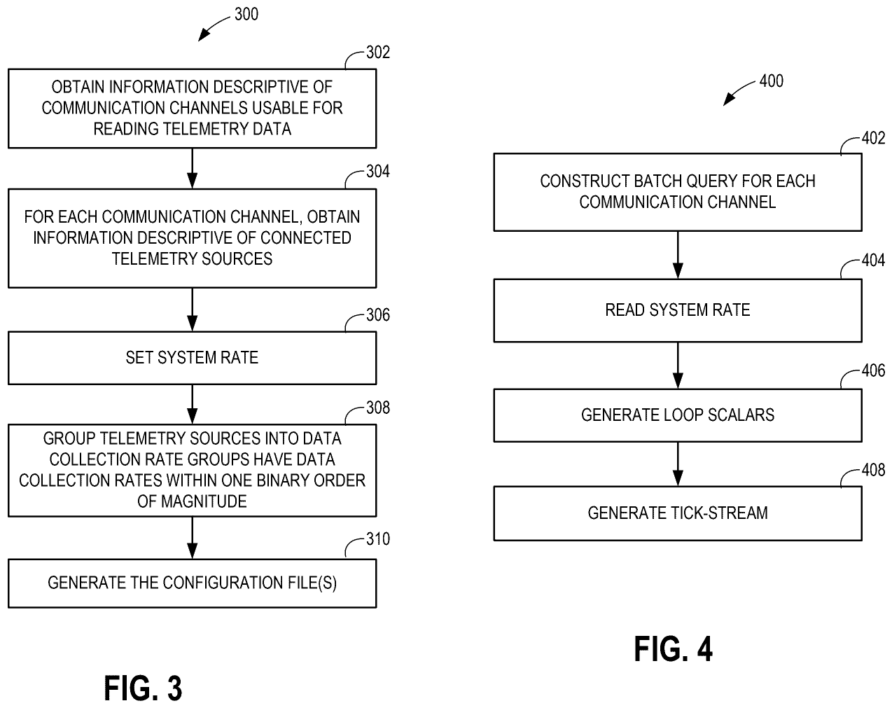

The system rate may be read from the configuration file and the loop scalars for each rate group can be generated from the inverse of the rate ratios. The system rate may define the number of ticks (e.g., potential reading events) for a period or cycle of the system (e.g., inverse of the system rate). A tick-stream can be generated as a serialized cyclic sequence of the ticks. The tick-stream can be constructed to identify, on a per-tick basis, active OOB communication channel 116A-116B and rate groups of sensors 110 that are to be read at each tick. In examples, the rate groups can be identified through a rate-group tuple. An example process for initializing the rate control logic is described below in connection with FIG. 4. The tick-stream can be stored to memory (e.g., memory 132).

Instructions 134 may also comprise rate control logic embodied as scheduler module 138 and one or more worker modules 140. In examples, each worker module 140 may be dedicated to or otherwise assigned to one of OOB communication channels 116A-116N. Each worker module 140 may be a thread of execution that can be executed by the processor(s) 128 to sample ones of sensors 110 connected to a respective OOB communication channel 116. For example, with reference to FIG. 1B, a first worker module 140 may be executed to sample ones of subset 110A of sensors 110 connected communication channel 116A, while a second worker module 140 may be executed to sample ones of subset 110B of sensors 110 connected to OOB communication channel 116B.

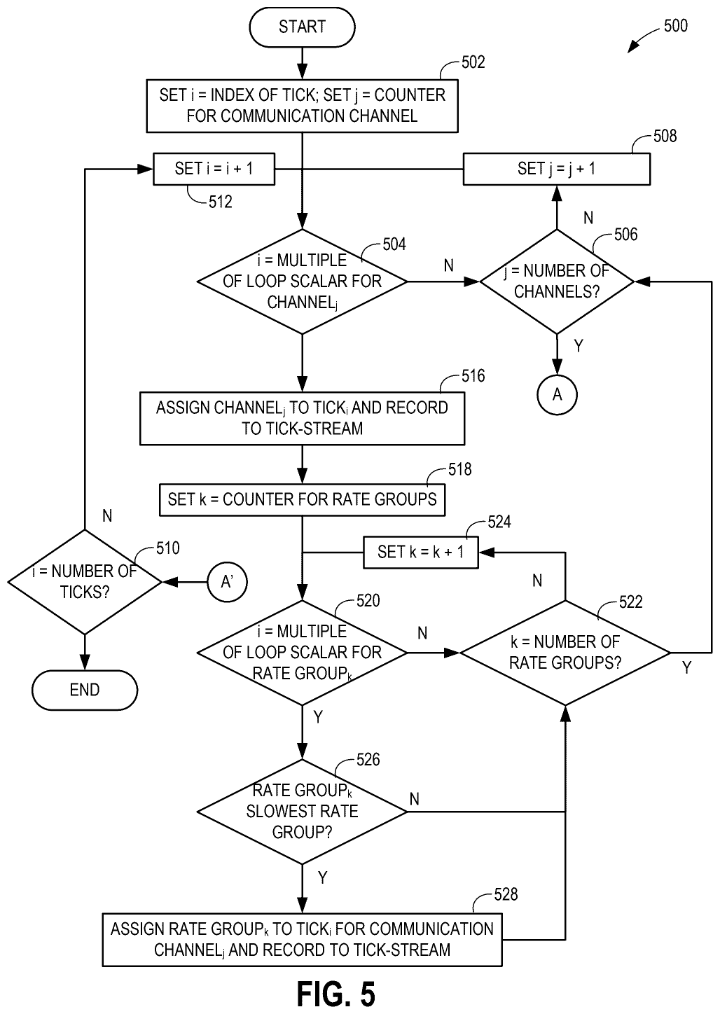

The scheduler module 138 may be, for example, a thread of execution that when executed by the processor(s) 128, determines which worker modules 140 are to be executed and which sensors 110 are to be sampled by referencing the tick-stream. For example, for each tick of the tick-stream, the scheduler module 138 may identify OOB communication channels 116 to be sampled for a given tick and signal respective worker modules 140 for sampling the identified OOB communication channels. The scheduler module 138 may also identify which sensors 110 are to be read for a given tick according to rate groups and obtain telemetry data via the identified OOB communication channels 116. An example process for executing the rate control logic is described below in connection with FIG. 5.

FIG. 3 illustrates an example process 300 for setting rate groups (also referred to as rate selection time), in accordance with an example implementation of the present disclosure. In examples, one or more operations of process 300 may be implemented as machine-readable instructions that may cause a processor to perform the operations described herein. In some examples, BMC 122, as described in connection with FIGS. 1A and 1B, may be implemented to execute one or more operations of process 300; for example, the rate selection module 136 may execute one or more operations of process 300.

At operation 302, information descriptive of communication channels that can be utilized for reading telemetry data can be obtained. For example, information descriptive of each communication channel that can be usable for reading telemetry data from connected telemetry sensors can be obtained. Referring to the example of FIGS. 1A and 1B, information can be for each OOB communication channel 116. In some examples, a user may input the information via a user interface. In other examples, the information may be discovered, for example, by referencing the information stored from a prior usage (e.g., a prior project). The obtained information may include, among other aspects, identifiers of each communication channel (also referred to as a bus ID), port number, a communication protocol (e.g., I²C, I³C, SPI, eSPI, or other protocol), identification of physical location, parental context, and a bus scan rate ratio, bus publication rate ratio, and one or more rate group scan rate ratios. Operation 302 may also include specifying a channel rate, for example, in the form a rate ratio (e.g., channel rate divided by the system rate). The channel rate may be equal to or slower than the system rate.

At operation 304, information descriptive of telemetry sensors connected to the communication channels identified in operation 302 may be obtained. For example, information descriptive of telemetry sensors, such as sensors 110 of FIGS. 1A and 1B, connected to OOB communication channels 116 may be obtained. The information may include identifiers of each telemetry source, as well as a target data collection rate, a minimum rate required to meet specified requirements. The target data collection rate may be defined by a user and may be equal to or greater than the minimum rate. The minimum rate may be based on, among other aspects, an importance or relevance of the sensed value (e.g., higher importance may translate to higher minimum rates), a rate of change of the underlying telemetry data to be sampled (e.g., higher rate of change may translate to higher minimum rates), an indication of whether or not the sampled reading necessitates averaging (e.g., averaging may translate to higher minimum rates), a required response time, whether a higher rate will result in improve quality of readings, if there are multiple telemetry sensors for sensing the same condition, a compute expense of processing the reading, and a capacity and speed of the readings to be stored. In some examples, a user may input the information via a user interface. In other examples, the information may be discovered, for example, by referencing the information stored from a prior usage (e.g., a prior project). The retrieved information may also include, among other aspects, an index, a device identifier, a name, physical context, refdes, device communication protocol, and address, among other information.

In some examples, target data collection rates may be obtained in operation 304 as a rate ratio (e.g., the specified frequency divided by the system rate). Operation 304 may also include translating the target data collection rate to an effective data collection rate by constraining an inverse of the rate ratio to whole numbers. In some cases, the minimum rate may operate as a barrier such that the effective data collection rate derived from a target data collection rate cannot be less than the minimum rate.

At operation 306, the system rate can be set. The system rate can be set to the lowest possible value that encompasses the data collection rates set forth in operation 304. That is, for example, the system rate can be set to a common multiple of the individual data collection rates (e.g., effective and/or target rates). As an illustrative example, if the data collection rates are 1 Hz, 10 Hz, and 100 Hz, then the system rate may be set to 100 Hz. Increasing the system rate above the lowest possible value (e.g., lowest common multiple of the various data collection rates) may have little impact on run-time compute utilization because the rate control logic can be encoded into a tick-stream (as described below in connection with FIG. 4). Thus, high system rates can be selected to support many different underlying data collection rates.

At operation 308, a plurality of rate groups can be formed for the telemetry sensors, such that telemetry sensors that make up a given rate group are associated with data collection rates that are within one binary order of magnitude of each other. Operation 308 may assign rate groups according to effective data collection rates. In some examples, some telemetry sensors may be assigned to a rate group corresponding to a data collection rate that marginally over-samples such telemetry sensors so as to force numeric compatibility within a given group and with respect to the system rate. That is, the effective data collection rate of a given telemetry source may be marginally adjusted to correspond to a particular data collection rate group, which may result in that telemetry source being marginally over-sampled.

At operation 310, a configuration file can be generated for reading the telemetry sensors by sampling the communication channels specified at operation 302. For example, a configuration file can be generated that includes, among other things, identifiers of each communication channel defined in operation 302, labels for each rate group, rate ratios of each telemetry sensor, and effective data collection rates for each telemetry sensor. In an example, labels for the rate groups may be max_scan_rate_ratio, moderate_scan_rate_ratio (or moderate_n_scan_rate_ratio, where there are more than one intermediate rate groups and “n” represents a value for indexing the intermediate rate groups), and a min_scan_rate_ratio. In an example, the bus scan rate ratio may be the maximum rate ratio associated for a high-speed data collection rate. In this case, the label may be bus_max_scan_rate_ratio. In some examples, a default rate ratio may be defined, for example, as default_rate_ratio, which may be the low-speed data collection rate (or another data collection rate as desired). The configuration file may tag each telemetry sensor with a corresponding data collection rate group. In examples, if a telemetry sensor is not allocated to a rate group in the configuration file, the telemetry sensor may be allocated to a default rate group, if a default rate group is defined. If a default rate group is not defined, the telemetry sensor may be included in the fastest defined data collection rate. In another example, the telemetry sensor may be included in the slowest defined data collection rate as the default rate group.

In examples, generating a configuration file at operation 310 may comprise generating and inserting information into a DIL (e.g., DIL 146 and/or DIL 200). For example, information obtained at operation 302 may be inserted into a system-level data table (e.g., system-level data table 204), while information obtained during operation 304 may be inserted into a channel level data table (e.g., one of channel level data table 206) and/or a device level data table (e.g., one of device level data tables 208). A DIL may comprise one or more of: the system-level data table, the channel level data table, and/or a device level data table. The DIL may be embodied as a DIL data structures comprising one or more of the above listed data tables. In some examples, a DIL data structure may include the channel level data table and, by extension, the device level data table. Additionally, a value may be entered into a column of the DIL that is representative of rate groups assigned to each telemetry sensor. This value may be a character string that specifies a rate group (e.g., “high-speed rate group”, “intermediate-speed rate group”, “low-speed rate group” or the like). In another example, the rate group may be defined by the rate ratio associated with each telemetry sensor.

In some examples, the configuration file (e.g., DIL in some examples) may sort the telemetry sensors from fastest rate group to slowest rate group. In the case of representing rate groups as rate ratios, this may translate to sorting from the largest rate ratio to smallest rate ratio. By sorting the telemetry sensors in this manner, rate groups associated with faster data collection rates (e.g., larger ratios) can be encapsulated by rate groups associated with slower data collection rates. Thus, when sampling telemetry sensors (as described below in connection with FIG. 5), telemetry sensors can be sampled according to the sorted order such that sampling can be stopped when a first telemetry source of a slower rate group is encountered. Thus, a current data collection rate group for a given tick can be sampled along with faster rate groups, but any slower rate groups can be skipped for the current tick and delayed until it is the appropriate time to sample the slower data collection rate group.

Furthermore, sorting the telemetry sensors as set forth above may enable loading all sampling events (e.g., the tick-stream) into a processor(s) 128 (e.g., an integrated circuit, such as, but not limited to an FPGA in some examples). Thus, at run time, the processor 128 may be triggered via a single command to sample the current data collection rate group and faster rate groups, with near computation resource utilization or input/output (I/O). As will be described below, this may be possible due to any modulus operations that may be needed and that are executed during initiation. In this way, modulus operations, which can be computationally taxing, can be avoided during run time.

FIG. 4 illustrates an example process 400 for initializing rate control in accordance with an example implementation of the present disclosure. In examples, one or more operations of process 400 may be implemented as machine-readable instructions that may cause a processor to perform the operations described herein. In some examples, BMC 122, as described in connection with FIGS. 1A and 1B, may be implemented to execute one or more operations of process 400, for example, the rate initialization module 142 may execute one or more operations of process 400.

At operation 402, a batch query can be constructed for each communication channel. For example, configuration files (e.g., configuration files generated at operation 310 of FIG. 3) can be loaded into a processor (e.g., processor(s) 106). Operation 402 may include building a query object that includes information and commands for sampling each telemetry sensor connected to each communication channel. For example, operation 402 may reference the configuration file to locate each telemetry sensor on each communication channel. Operation 402 may then build a query object for each communication channel, which includes an address (e.g., location) of each telemetry sensor, command codes for sampling and reading each telemetry sensor (e.g., codes and logic that are executable by a processor to perform a reading), and a size (e.g., in terms of memory space) of an expected response (e.g., telemetry data) from each telemetry sensor. The telemetry sensors may be sorted in order of data collection rates (e.g., specified as rate ratios) from fastest data collection rate (e.g., largest rate ratio) to slowest data collection rate (e.g., smallest rate ratio).

In examples, the query object may be loaded into a processor (e.g., processor(s) 128) during operation 402. In this case, the query object may not be initiated until run time (e.g., as described below in connection with FIG. 5). In examples, the query object may be loaded into the processor by a driver (e.g., a programming controller) that writes the query object to a setup register. The driver, in this example, iterates through the telemetry sensors according to the sorted order (e.g., fastest to slowest data collection rates) and writes commands necessary for executing a reading for each telemetry sensor.

At operation 404, the system rate may be read from memory. For example, the system rate, set in operation 306 of FIG. 3, may be read in from the configuration files or memory storing the system rate.

At operation 406, loop scalars may be generated from rate ratio. For example, loop scalars may be generated from rate ratios set forth in the configuration file. In examples, the configuration file may comprise rate ratios for each telemetry sensor, as well as each communication channel (e.g., as described above in connection with FIG. 3). A loop scalar may be generated from the inverse of the rate ratio. For example, a loop scalar for each communication channel may be generated from the rate ratio specified for each respective communication channel. Similarly, loop scalars for the telemetry sensors may be generated from the rate ratios of each respective telemetry sensor. In examples, loops scalars are constrained to whole numbers (e.g., any integer greater than zero). In examples, any loop scalar that is not a whole number may be rounded to the nearest whole number to conform to this constraint. In this example, the rate ratio (and corresponding effective data collection rate) used to generate the loop scalar may be updated accordingly, subject to the minimum rate as a barrier. As a result, each rate group may be associated with a common loop scalar. In another example, any loop scalar that is not a whole number may be rejected as invalid.

At operation 408, a tick-stream is generated based on the system rate (e.g., operation 404) and the loop scalars (e.g., operation 406). For example, the system rate can be converted to a system period (e.g., inverse of the system rate), and a total number of potential read events or ticks may be based on the system rate. In examples, the total number of ticks may be computed as a period of the slowest rate group divided by the system period. As an illustrative example, if the system rate is 100 Hz and the slowest rate group is 1 Hz, the total number of ticks may be 100 ticks (e.g., 100 potential reads within one second). In another example, if the system rate is 100 Hz and the slowest rate group is 0.1 Hz, the total number of ticks may be 1000 ticks (e.g., 1000 potential reads within one second). Each tick can then be modulated by the loop scalars to determine which communication channel is to be sampled and which rate group (e.g., which telemetry sensors) is to be read for a given tick. Thus, the tick-stream may comprise a sequentially ordered set of ticks, with communication channels and data groups assigned to ticks at which the communication is to be sampled and rate groups are to be read. In examples, only the slowest rate group for a given tick need be assigned to the tick due to encapsulation of faster rate groups within slower rate groups. FIG. 5 below provides an example process for generating a tick-stream in accordance with an example implementation.

In an example, the tick-stream can be generated as a data structure of sequential bytes of data, where each byte of data represents a tick. Each byte can store a number of communication channels to be sampled during the tick represented by a respective byte, identifier of the communication channels, and rate groups to be read during the respective tick. In examples, the identifiers of the communication channels can be associated with rate groups for that communication channel. For example, the byte of a given tick may comprise channel/rate group tuples, where each tuple comprises an identifier of a communication channel and a rate group to be ready via the associated communication channel. If a tick is not assigned any communication channels and/or rate groups, then the byte corresponding to that tick may be empty. To construct the tick-stream in this way, a byte of data can be generated for each tick and the number of communication channels to be sampled and rate groups to be read during each tick and be written into the byte sequentially.

FIG. 5 illustrates an example process 500 for generating a tick-stream, in accordance with an example implementation of the present disclosure. Process 500, in some examples, may be executed as a sub-operation of operation 408 described above.

At operation 502, an index i, a counter for ticks in the tick stream, and an index j, a counter for the communication channels, can be provided. Initially, i can be set to an index of the first tick of the tick stream and j can be to an index scheme of a first communication channel potentially usable for sampling telemetry data (e.g., comprising connected telemetry sensors).

At operation 504, a determination is made as to whether or not the loop scalar of the current jth communication channel (e.g., the first communication in this case) is a multiple of index i (e.g., one at this point) of the current ith tick. As noted above, loop scalars may be constrained to whole numbers.

If the determination is negative, process 500 proceeds to operation 506, where a determination is made as to whether or not the counter j for indexing communication channels has reached a number of total communication channels potentially available for sampling telemetry data. If the counter j has not yet reached the number of total communication channels, the operations can proceed to operation 508, where the counter j used for indexing the communication channels can be incremented to the next communication channel. The process 500 may then repeat operation 504 for the next communication channel. If the counter j has reached the number of total communication channels, then the operations can proceed to operation 510.

At operation 510, a determination is made as to whether or not the counter i for indexing ticks has reached a number of total ticks. If the counter i has not yet reached the number of total ticks, the process can proceed to operation 512, where the counter i used for indexing the ticks can be incremented to the next tick of the tick stream. The process 500 may then repeat operation 504 for the next tick. If the counter i has reached the number of total ticks, then the process can end.

If the determination at operation 504 is affirmative, process 500 proceeds to operation 516, where the current communication channel (e.g., jth communication channel) can be assigned to the current tick (e.g., ith tick). In examples, as described above, each tick can be represented as a byte in the tick stream, and operation 516 may include writing the identifier of the ith communication channel to the byte representing the ith tick.

At operation 518, an index k, a counter for rate groups can be set. Initially, k can be set to an index of the first rate group. In examples, the rate groups may be sorted from fastest to slowest rate group in the configuration file, thus, the first rate group may be the fastest rate group.

At operation 520, a determination is made as to whether or not the loop scalar of the jth rate group (e.g., the first communication in this case) is a multiple of index i of the current tick. As noted above, loop scalars may be constrained to whole numbers.

If the determination is negative, process 500 proceeds to operation 522, where a determination is made as to whether or not the counter k for indexing communication channels has reached a number of total rate groups. If the counter k has not yet reached the number of total rate groups, the process can proceed to operation 524, where the counter k used for indexing the rate groups can be incremented to the next rate group. The process 500 may then repeat operation 520 for the next rate group. If the counter k has reached the number of total rate groups, then the operations can proceed to operation 506 described above.

If the determination at operation 520 is affirmative, process 500 proceeds to operation 526, where a determination is made whether or not the current rate group is the slowest rate group. If the current rate group is not the slowest rate group, process 500 proceeds to operation 522. Otherwise, process 500 proceeds to operation 528, where the current rate group (e.g., kth communication channel) can be assigned to the current tick (e.g., ith tick). Thus, the slowest rate group is assigned to the tick and, due to encapsulation as described above, includes any faster rate groups indirectly. In examples, as described above, each tick can be represented as a byte in the tick stream, and operation 528 may include writing a tuple to the byte representing the current tick. The tuple may comprise the identifier of the current communication channel and the assigned rate group.

When the process ends (e.g., the determination at operation 510 is negative), the tick-stream generated through process 500 can be stored in a memory (e.g., memory 132 of FIG. 1B). The total number of communication channels assigned to each tick can be determined, for example, upon a positive determination at operation 506. The total number can be associated with the current tick (e.g., prior to incrementing the index i at operation 512). As outlined above, the tick-stream may comprise each tick represented as a byte that stores the total number of communication channels assigned to the tick and a tuple of each communication channel identifier and assigned rate groups.

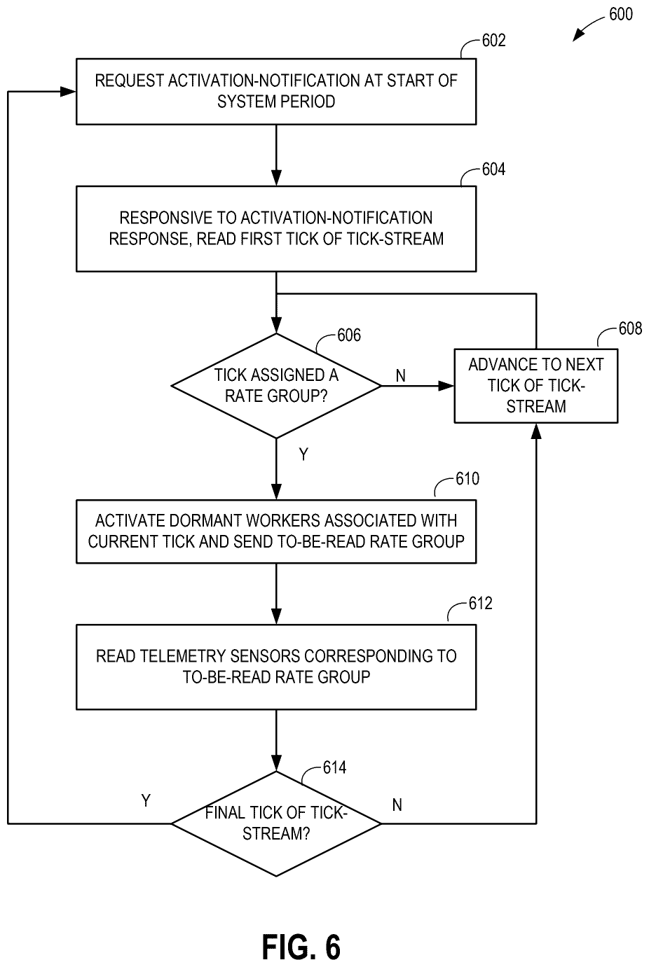

FIG. 6 illustrates an example process 600 for executing rate control in accordance with an example implementation of the present disclosure. In examples, one or more operations of process 600 may be implemented as machine-readable instructions that may cause a processor to perform the operations described herein. In some examples, BMC 122, as described in connection with FIGS. 1A and 1B, may be implemented to execute one or more operations of process 600, for example, rate control logic (e.g., scheduler module 138 and worker module(s) 140) may execute one or more operations of process 600.

At operation 602, an activation-notification may be requested at the start of a system period. In examples, a scheduler (e.g., scheduler module 138) may request the activation-notification from an operating system (e.g., operating system 170 of FIG. 1A) at the start of a system period.

At operation 604, responsive to receiving a response to the activation-notification, the tick-stream can be accessed and the first tick read from the tick-stream. If the first tick is assigned a rate group (operation 606), workers (e.g., worker modules 140) assigned to a current tick, as set forth in the tick-stream, may be activated and a to-be-activated rate group can be sent to the newly activated workers (operation 610). In examples, each worker may be associated with a communication channel. Thus, operation 610 may include activating those workers associated with communication channels assigned to the current tick. Furthermore, each communication channel may be associated with a rate group (e.g., a slowest rate group). The to-be-activate rate group may comprise the rate group assigned to the current tick and any faster rate groups encapsulated by the assigned rate group.

In an example, the scheduler may access the tick-stream stored in memory (e.g., memory 132) and read a byte representing the first tick. By reading the byte, the scheduler can determine if any rate groups are assigned to the current tick (operation 606). For example, the scheduler may read a number of communication channels that are to be active (e.g., sampled). Then the scheduler may read the tuples stored to the byte and activate those workers associated with communication channels identified in the tuples (operation 610). The rate groups identified in the tuples may correspond to the slowest rate group, which can be used to define the to-be-activated rate group.

At operation 612, the telemetry sensors corresponding to the to-be-activated rate group can be read by sampling the communication channels assigned to the tick. For example, each worker may operate to obtain telemetry data from the to-be-active rate group by causing each telemetry sensor included in the to-be-activated rate group to be read. Additional details are provided below in connection with FIG. 7.

Once the telemetry data is obtained, operation 614 determines if the current tick is the final tick of the tick-stream. If the determination is negative, the tick-stream is advanced to the next tick at operation 608 and process 600 repeats operation 606. For example, the tick-stream can be advanced by reading the next byte, which is left pointing to data for the next tick. Similarly, if the determination at operation 606 is negative, the process 600 proceeds to operation 608. If the determination at operation 614 is positive (e.g., end of the tick-stream), the process proceeds to operation 602 where it waits for the start of the next system period.

In examples, during the next system period, process 600 can utilize the same tick-stream as used during the prior system period. Since this tick-stream is stored in memory as data, process 600 need not compute which communication channels are to be activated nor which telemetry sensors are to be read at each tick. Instead, determinations are made simply by referencing a pre-stored tick-stream. Thus, repetitive modulus operations can be avoided.

FIG. 7 depicts an example architecture 700 and process flow for executing a rate control run time, in accordance with an example implementation. The architecture comprises an application layer 702, a user space 704, a kernel space 706, and a hardware space 708. The application layer 702 may be an example implementation of application layer 156 of FIG. 1. The user space 704 may be an example of an operating system 170. Kernel space 706 may be, for example, an operating system kernel mount interface as described above in connection with FIG. 1A. Hardware space 708 may represent the physical hardware components, such as the hardware components of computer resource 100A for FIG. 1A.

Application layer 702, in this example, may include application instances associated with one or multiple clients at any particular time. In the example of FIG. 7, application layer 702 includes one or more polling application 710 for requesting and receiving data from the user space 704. Application layer 702 may also include one or more subscription applications 712, which may be configured to receive data.

User space 704, in this example, includes a frontend 714 and data storage platform 716, such as, but not limited to, Redis. User space 704 may also include a power management (PM) counter 718 configured to count a number of warning events that are based on telemetry data. Frontend 714 may include a dashboard 715, which a user may interact with to submit queries and receive response to queries. For example, a user may submit a query to dashboard 715 requesting telemetry data. The frontend 714 may format the query and obtain data from storage platform 716 and/or polling app 710 relevant to the query. The obtained data may be formatted and displayed to the user as a response via dashboard 715.

Hardware space 708 comprises a processing component 728, illustratively shown as an FPGA, and a plurality of devices 730 connected to the processing component 728 via one or more communication channels 732 (illustratively shown as a single communication channel for ease of illustration), such as OOB communication channels 109 of FIGS. 1A and 1B. Each device 730 comprises one or more telemetry sensor 734 (e.g., sensors 110 of FIG. 1).

User space 704 can further include one or more worker modules 720A-720N (e.g., worker module 140). Each worker module 720A-720N may be associated with a communication channel of the one or more communication channels 732. For example, each worker module 720A-720N can be executed to cause the processing component 728 to sample a respective communication channel 732 and obtain telemetry data by reading telemetry sensor 734 connected to the respective communication channel 732.

Each worker module 720A-720N may comprise a respective scan loop module 722 and a respective abstraction library 724. The scan loop module 720 may interface with a scheduler 726 (e.g., scheduler module 138). The scheduler 726 may access a configuration file stored in memory (e.g., memory 132 of FIG. 1B), which can be constructed in accordance with FIG. 3. The scheduler 726 may execute one or more operations of process 600 described above. For example, the scheduler 726 can request activation-notification from the operating system at the start of a system period. Based on (e.g., responsive to) receiving an activation-notification response, the scheduler 726 may read a first tick of a tick-stream (e.g., a first byte of the tick-stream) generated, for example, in accordance with FIGS. 4 and 5. The scheduler 726 reads the number of communication channels and rate group/channel ID tuples assigned to the first tick (e.g., as represented by data stored in the first byte).

For each channel ID, the scheduler 726 signals a corresponding worker module, which may be dormant prior to the signaling. In the example of FIG. 7, scheduler 726 signals worker module 720A by sending the worker module 720A a to-be-activated rate group for the current tick at operation 736. For example, scheduler 726 may access the configuration file (e.g., DIL) and locate the rate group (e.g., the slowest rate group assigned to the tick) from a table of telemetry sensors (e.g., device level data table 208A of FIG. 2). Scheduler 726 may pull a subset of the telemetry sensor listed in the table. This subset includes all the telemetry sensors between the first telemetry in the table (e.g., fastest data collection rate) to the last telemetry sensor of the rate group assigned to the tick. This subset of telemetry sensors represents the to-be-activated rate group, for example, telemetry sensors corresponding to the slowest rate group assigned to the tick and those corresponding to rate groups encapsulated within the slowest rate group. The scheduler 726 sends this to-be-activated rate group to the worker module 720A.

The worker module 720A may call “Get Readings” functions for the to-be-activated rate group at operation 738. The “Get Readings” functions include commands and information for reading the telemetry sensors corresponding to the to-be-activated rate group on a telemetry sensor-basis. That is, worker module 720A may execute operation 738 to obtain commands and information for reading each telemetry sensor of the to-be-activated rate group. In some example, operation 738 may include calling a DIL data structure generated according to FIG. 3, as described above. For example, the “Get Readings” function may take a DIL data structure comprising a channel level data table (e.g., one of channel level data table 206) and a device level data table (e.g., one of device level data tables 208).

At operation 740, the to-be-activated rate group can be assigned to one of communication channels 732. For example, prior to operation 740, the worker module 720A may be dedicated to a particular communication channel, for example, as specified in a DIL data structure called at operation 738. Operation 740 may include accessing the DIL data structure to retrieve the particular communication channel assigned to worker module 720A and signal sampling the to-be-activate rate group using the particular communication channel to the to-be-activated rate group. For example, the DIL data structure may include a channel ID of the communication channel dedicated to the worker module 720A. Operation 740 may retrieve this channel ID and signal using the communication channel corresponding to the channel ID for sampling the to-be-activated date group.

The worker module 720A may then determine if the processing component is offloading or not at operation 742. The determination at operation 742 may be negative during an initialization rate control (e.g., process 400 of FIG. 4). In this case, worker module 720A may record a current time (operation 744), for example, as a time stamp, and construct a batch query as described above (operation 746), for example, in connection with FIG. 4. Since the user space 704 and the kernel space 706 may not actually sample the telemetry sensor 734, the worker 720A writes commands to the processing component 728 and start control register 754 causes the processing component 728 to start sampling, as will be described below. In examples, processing component 728 may not have sufficient memory to handle timestamps, for example, in the case of an FPGA. Thus, in order to record time a time of the readings, the worker 720A records a time (e.g., a timestamp) as close to the point in time when the reading is actually sampled. Thus, worker 720A may record time at operation 744 and/or the driver 748 may record a time at operation 758, as described above. In the case of operation 746, there may be only one more operation, for example, operation 748 that writes to the control register 750. Thus, this time may be accurate with respect to operation 748.

At operation 746, the worker module 720A may call an interface (e.g., an API) for the targeted communication channel, as indicated by the channel ID obtained at operation 740, and send the batch query to the kernel space 706 via the interface. The batch query comprises commands and instructions for reading all of the telemetry sensors 734 connected to the targeted communication channel.

The kernel space 706 may comprise a driver 748 (also referred to as a programming controller) for the processing component 728. The driver 748 executes operation 75, which writes the batch query 762 into a setup register 752 of the processing component 728. In examples, the telemetry sensors in the batch query are sorted from fastest to slowest data collection rate and the driver 748 may iterate over writing to the setup register 750 according to the sorted order. In examples, the batch query 762 can be written as a set of commands necessary for executing a reading for each telemetry sensor. The command are sorted according to rate group, such as in the order of commands 762A for reading telemetry data from telemetry sensors of the fastest rate group, commands 762B for reading telemetry data from telemetry sensors of one or more intermediate rate groups, and commands 762C for reading telemetry data from telemetry sensors of the slowest rate group. While commands are written into the processing component 728 for execution, the processing component 728 does not initiate a query transaction (e.g., does not execute the commands of batch query 762) until a control register 752 is modified, for example, by the driver 748.

For example, if the determination at operation 742 is affirmative, worker module 720A sends a size of the to-be-activate rate group to the driver 748 (operation 756). For example, worker module 720A determines a size of the to-be-activated rate group by counting a number N of telemetry sensors included in the to-be-activated rate group. The worker module 720A may call the interface (e.g., the API) for the targeted communication channel, as indicated by the channel ID obtained at operation 740, and send the number N to the driver 748.

The driver 748 may record a current time (operation 758), for example, as a time stamp. That is, driver 748 may record the current time as close as possible to causing the processing component 728 to trigger a reading. At operation 760, the driver 748 may send the group size to the control register 754 of the processing component 728. For example, the driver 748 may write the number N into the control register 754. This number N may indicate to the control register 754 a number of commands of the batch query 762 to be executed for reading telemetry sensors corresponding to the to-be-activate rate group.

Upon receiving the group size, the control register 754 may trigger a query transaction and executes some or all of the commands of batch query 762 corresponding to the batch size. For example, the control register 754 may cause the processing component 728 to execute the first N commands of the batch query 762. Since the number N corresponds to the size of the to-be-activated rate group and the batch query 762 is sorted according to rate group, the query transaction executes the commands for reading the telemetry sensors of the to-be-activated rate group (e.g., the slowest rate group assigned to the current tick and all encapsulated rate groups). Depending on the rate group assigned to the current tick, the control register 754 may cause processing component 728 to execute commands 762A for the fastest rate group, commands 762A and 762B for the one or more intermediate rate group-including encapsulated fastest rate group, or commands 762A-762C for the slowest rate group-including encapsulated intermediate and fastest rate groups.

By executing the commands, the processing component 728 samples the communication channel 732 and reads telemetry data from registers 764 of the telemetry sensors 734. The processing component 728 obtains the raw telemetry readings 766 and returns the readings to the driver 748 at operation 768. Upon receiving the readings via operation 768, the worker module 720A can signal the scheduler 726 that the commands have been executed and telemetry data has been obtained for the current tick. The scheduler may then advance the tick-stream to the next tick and repeat the process from operation 736 for the next tick.

While the above description is provided with reference to a single worker module 720A, examples herein are not limited to a single worker. As noted above, user space 704 may include a multiple workers 720A-720N, which can be activated for a given tick-based channel IDs assigned to the tick. In the event that multiple channel IDs are assigned to a given tick, scheduler 726 activates multiple workers, one for each channel ID. Each worker performs the operations described above to cause processing component 728 to execute commands and obtain results. In this case, the scheduler 726 waits for each worker to signal that telemetry data has been obtained (e.g., each worker receives readings via a respective operation 768). In some examples, the processing component 728 may comprise distinct architectures, each corresponding to (e.g., dedicated to) a worker module of worker modules 720A-720N. For example, the processing component may include multiple instances of setup registers and/or start control registers, each of which may be dedicated to one worker module (e.g., first instance of setup register 752 and a first instance start control register 754 dedicated to worker module 720a, another instance of setup register 752 and another instance of start control register 754 dedicated to worker module 720B, and so on). Once all workers have signaled completion, the scheduler 726 may advance the tick-stream to the next tick and repeat the process from operation 736 for the next tick.

The raw telemetry data can then be processed and provided to the user space 704 via the interface, which can perform further processing that transforms the raw telemetry data into usable telemetry data that can be utilized by the applications layer 702 for monitoring conditions relating to an environment and/or health of the computer resource.

FIG. 7 illustrates examples of optional processing operations, one or more of which may be applied to the raw telemetry data. However, examples herein are not limited to these steps, which are provided for illustrative purposed only. For example, telemetry data can be normalized (optional operation 770) and post-processing (optional operation 772) can be applied, such as averaging, rolling averages, time series analysis and the like. Synthetic values and/or KPI can be computed at optional operation 774, for example, power consumption can be computed from telemetry data of current and voltages. Limits can be checked at optional operation 776, for example, by comparing processed telemetry data (e.g., from operation 772) and/or the synthetic values/KPIs (e.g., from operation 776) to thresholds for detecting anomalous behavior. Warnings or other alerts may be generated at operation 776 to record detected instanced. The information—including one or more of raw telemetry data, synthetic values/KPIs, processed telemetry data, or warnings/alerts—may be published at optional operation 778 and recorded to the data storage platform 716. The published information can be accessed and presented via the frontend 714, for example, via a dashboard 715 that displays information responsive to and formatted according to a query from the application layer (e.g., polling application 710 in this example) and/or user (e.g., input into dashboard 715). Additionally, the published information can be provided to PM counter 718 that monitors and counts a number of warning/alert events so to notify users of potential issues. Further still, in some examples, the published data can be supplied to the subscription application 712 for use according to the subscription.

While the examples described in connection with FIGS. 6 and 7 provide for requesting an activation-notification and accessing the tick-stream responsive to a response, the technology disclosed herein are not limited to these examples. For example, the processes described in connection with FIGS. 6 and 7 may be triggered without signaling the scheduler. Instead, the scheduler may access the tick-stream at the start of the system period and proceed as described above. In this case, telemetry data read by sampling the communication channels assigned to a current tick (e.g., operation 612 and/or raw telemetry readings 766) may be added to a publishing queue (e.g., operation 778). In this case, operation 778 may execute a publishing thread of execution that periodically empties the queue. Emptying the queue may include publishing the telemetry data according to a publishing rate, as described above, pushing the telemetry data to the data storage platform 716. In another example, emptying or clearing the telemetry data from the queue, for example, without storing to the data storage platform 716.

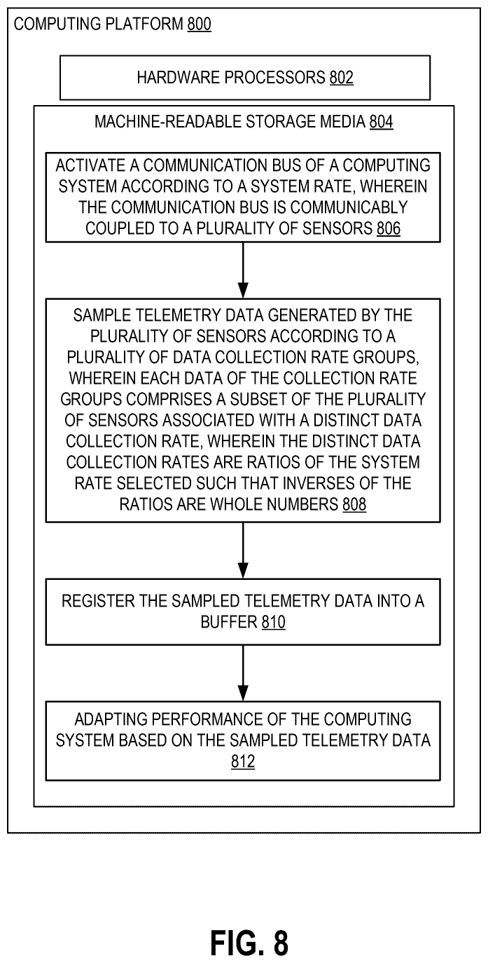

FIG. 8 illustrates a computing component that may be used to implement rate control in accordance with various examples of the disclosed technology. Referring now to FIG. 8, computing component 800 may be, for example, a server computer, a controller, or any other similar computing component capable of processing data. In the example implementation of FIG. 8, the computing component 800 includes a hardware processor 802 and machine-readable storage medium 804.

Hardware processor 802 may be one or more central processing units (CPUs), semiconductor-based microprocessors, and/or other hardware devices suitable for retrieval and execution of instructions stored in machine-readable storage medium 804. Hardware processor 802 may fetch, decode, and execute instructions, such as instructions 806-812, to control processes or operations rate control. As an alternative—or in addition—to retrieving and executing instructions, hardware processor 802 may include one or more electronic circuits that include electronic components for performing the functionality of one or more instructions, such as a field programmable gate array (FPGA), application-specific integrated circuit (ASIC), or other electronic circuits.

A machine-readable storage medium, such as machine-readable storage medium 804, may be any electronic, magnetic, optical, or other physical storage device that contains or stores executable instructions. Thus, machine-readable storage medium 804 may be, for example, Random Access Memory (RAM), non-volatile RAM (NVRAM), an Electrically Erasable Programmable Read-Only Memory (EEPROM), a storage device, an optical disc, and the like. In some examples, a machine-readable storage medium 804 may be a non-transitory storage medium, where the term “non-transitory” does not encompass transitory propagating signals. As described in detail below, machine-readable storage medium 804 may be encoded with executable instructions, for example, instructions 806-812.

Hardware processor 802 may execute instruction 806 to activate a communication bus of a computing system according to a system rate. The communication bus may be communicably coupled to a plurality of sensors. For example, the computing system may be a computer resource 102 and/or a BMC 122 as described in connection with FIGS. 1A and 1B. The communication bus may be, for example, an OOB communication channel 116 connected to sensors 110 of FIGS. 1A and 1B.

Hardware processor 802 may execute instruction 808 to sample telemetry data generated by the plurality of sensors according to a plurality of data collection rate groups. Each data of the collection rate groups may comprise a subset of the plurality of sensors associated with a distinct data collection rate. The distinct data collection rates may be ratios of the system rate selected such that inverses of the ratios are whole numbers. The plurality of data collection rate groups can be defined and initialized in the computing system as described above in connection with FIGS. 1A-5.

In examples, the distinct data collection rates may comprise a high-speed data collection rate, one or more intermediate-speed data collection rates, and a low-speed data collection rate. As an example, the low-speed data collection rate is 1 Hz, the high-speed data collection rate is 100 Hz, and an intermediate-speed data collection rate of the one or more intermediate-speed data collection rates is 10 Hz. However, other data collection rates may be implemented as desired for a given application (e.g., 0.1 Hz as the slowest rate). In some examples, the low-speed data collection rate can be synchronized with the high-speed data collection rate and the one or more intermediate-speed data collection rates, for example, by encapsulating the high-speed data collection rate within the one or more intermediate-speed data collection rates and encapsulating the one or more intermediate-speed data collection rates within the low-speed data collection rate. That is, for example, a data collection rate of a given speed, other than highest speed data collection rate, can be synchronized only with an adjacent and faster speed of data collection rate (e.g., lowest data collection rate can be synced with the lowest intermediate data collection rate, which is synced with the next lowest intermediate if applicable or the highest speed data collection rate). As another example, the one or more intermediate-speed data collection rates may be synchronized with the high-speed data collection rate, for example, by encapsulating the high-speed data collection rate.

In the above examples, sampling of data collection rate groups can be synchronized according to the encapsulation. For example, a first data collection rate group of the plurality of data collection rate groups can be sampled at the high-speed data collection rate, while a second data collection rate group and the first data collection rate group of the plurality of data collection rate groups can be sampled at the low-speed data collection rate.

In some examples, hardware processor 802 may execute instruction 808 to activate the communication bus according to a bus rate, for example, as described above in connection with FIGS. 6 and 7. In this case, an inverse of a ratio of the bus rate with the system rate may be a whole number and the bus rate may be synchronized with the distinct data collection rates. In this example, instruction 800 may cause hardware processor 802 to sample the telemetry data generated by the plurality of data collection rate groups at a respective distinct data collection rate.

Hardware processor 802 may execute instruction 810 to register the sampled telemetry data into a buffer. For example, the telemetry data may be registered into buffer 144 of FIG. 1B and/or as described in connection with FIGS. 6 and 7.

Hardware processor 802 may execute instruction 812 to adapt performance of the computing system based on the sampled telemetry data. For example, performance of the computing system may be adapted or changed based on processing the telemetry data and/or deriving synthetic values/KPIs, for example, in a manner that seeks to optimize computation resources or avoid dangerous conditions (e.g., running hot that could cause damage). Examples herein may shift client tasks to other computing systems or other computation resources of the computing system to optimize conditions.

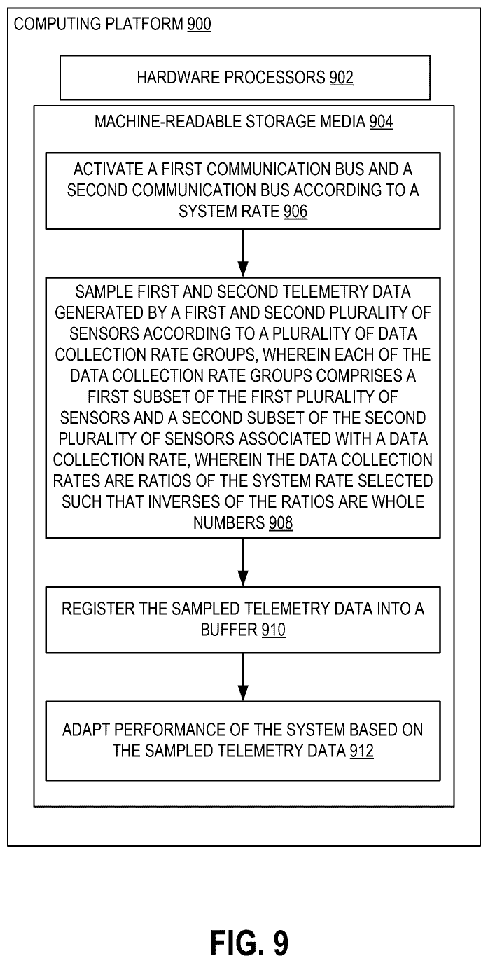

FIG. 9 illustrates another computing component that may be used to implement various features of rate control in accordance with various examples of the disclosed technology. Referring now to FIG. 9, computing component 900 may be, for example, a server computer, a controller, or any other similar computing component capable of processing data. In the example implementation of FIG. 9, the computing component 900 includes a hardware processor 902 and machine-readable storage medium for 904.

Hardware processor 902 may be one or more central processing units (CPUs), semiconductor-based microprocessors, and/or other hardware devices suitable for retrieval and execution of instructions stored in machine-readable storage medium 904. Hardware processor 902 may fetch, decode, and execute instructions, such as instructions 906-912, to control processes or operations rate control. As an alternative or in addition to retrieving and executing instructions, hardware processor 902 may include one or more electronic circuits that include electronic components for performing the functionality of one or more instructions, such as a field programmable gate array (FPGA), application-specific integrated circuit (ASIC), or other electronic circuits.

A machine-readable storage medium, such as machine-readable storage medium 904, may be any electronic, magnetic, optical, or other physical storage device that contains or stores executable instructions. Thus, machine-readable storage medium 904 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 904 may be a non-transitory storage medium, where the term “non-transitory” does not encompass transitory propagating signals. As described in detail below, machine-readable storage medium 904 may be encoded with executable instructions, for example, instructions 906-912.

Hardware processor 902 may execute instruction 906 to activate a first communication bus and a second communication bus according to a system rate. In examples, the first communication bus can be communicably coupled to a first plurality of sensors configured to generate first telemetry data of the system and the second communication bus can be communicably coupled to a second plurality of sensors configured to generate second telemetry data of the system. In an example, the first and second communication buses may be, for example, OOB communication channels 116 connected to sensors 110 of FIGS. 1A and 1B.

Hardware processor 902 may execute instruction 908 to sample first and second telemetry data generated by a first and second plurality of sensors according to a plurality of data collection rate groups. In examples, each of the data collection rate groups comprises a first subset of the first plurality of sensors and a second subset of the second plurality of sensors associated with a data collection rate. The data collection rates may be constrained to ratios of the system rate selected such that inverses of the ratios are whole numbers. The plurality of data collection rate groups can be defined and initialized in the computing system as described above in connection with FIGS. 1A-5 and the sampling of the telemetry sensors may be executed as described in connection with FIGS. 6 and 7.

In examples, the distinct data collection rates may comprise a high-speed data collection rate, one or more intermediate-speed data collection rates, and a low-speed data collection rate. As an example, the low-speed data collection rate is 1 Hz, the high-speed data collection rate is 100 Hz, and an intermediate-speed data collection rate of the one or more intermediate-speed data collection rates is 10 Hz. However, other data collection rates may be implemented as desired for a given application (e.g., 0.1 Hz as the slowest rate). In some examples, the low-speed data collection rate can be synchronized with the high-speed data collection rate and the one or more intermediate-speed data collection rates, for example, by encapsulating the high-speed data collection rate and the one or more intermediate-speed data collection rates. As another example, the one or more intermediate-speed data collection rates may be synchronized with the high-speed data collection rate, for example, by encapsulating the high-speed data collection rate.

In an example, hardware processor 902 may execute instruction 908 to sample a first subset of the first plurality of sensors corresponding to the first data collection rate group of the plurality of data collection rate groups at the high-speed data collection rate associated with a first data collection rate group. In this example, hardware processor 902 may also execute instruction 908 to sample a second subset of the second plurality of sensors corresponding to the second collection rate group of the plurality of data collection rate groups and the first subset of the first plurality of sensors corresponding to the first data collection rate group at the low-speed data collection rate associated with a second data collection rate group.

In an example, hardware processor 902 may execute instruction 908 to sample a first subset of a first data collection rate group of the plurality of data collection rate groups at the high-speed data collection rate. In this example, hardware processor 902 may also execute instruction 908 to sample a first subset of a first data collection rate group, a second data collection rate group, and the first data collection rate group of the plurality of data collection rate groups at the low-speed data collection rate.

In an example, hardware processor 902 may execute instruction 908 to signal a first worker circuit associated with the first communication bus. In this case, the first worker may activate the first communication bus according to a first bus rate. The inverse of a ratio of the first bus rate with the system rate may be constrained to a whole number and the first bus rate may be synchronized with the distinct data collection rates. The first worker may also sample the first telemetry data generated by the plurality of data collection rate groups at a respective distinct data collection rate.

The hardware processor 902 may also execute instruction 908 to signal a second worker circuit associated with the second communication bus. In this case, the second worker may activate the second communication bus according to a second bus rate. An inverse of a ratio of the second bus rate with the system rate may be constrained to a whole number. The second bus rate may be synchronized with the distinct data collection rates. The second worker may also sample the second telemetry data generated by the plurality of data collection rate groups at a respective distinct data collection rate. An example of such is described above in connection with FIG. 7.

Hardware processor 902 may execute instruction 910 to register the sampled telemetry data into a buffer. For example, the telemetry data may be registered into buffer 144 of FIG. 1B and/or as described in connection with FIGS. 6 and 7.

Hardware processor 902 may execute instruction 912 to adapt performance of the system based on the sampled telemetry data. For example, performance of the system may be adapted or changed based on processing the telemetry data and/or deriving synthetic values/KPIs, for example, in manner that seeks to optimize computation resources or avoid dangerous conditions (e.g., running hot that could cause damage). Examples herein may shift client tasks to other systems or other computation resources of the system to optimize conditions.

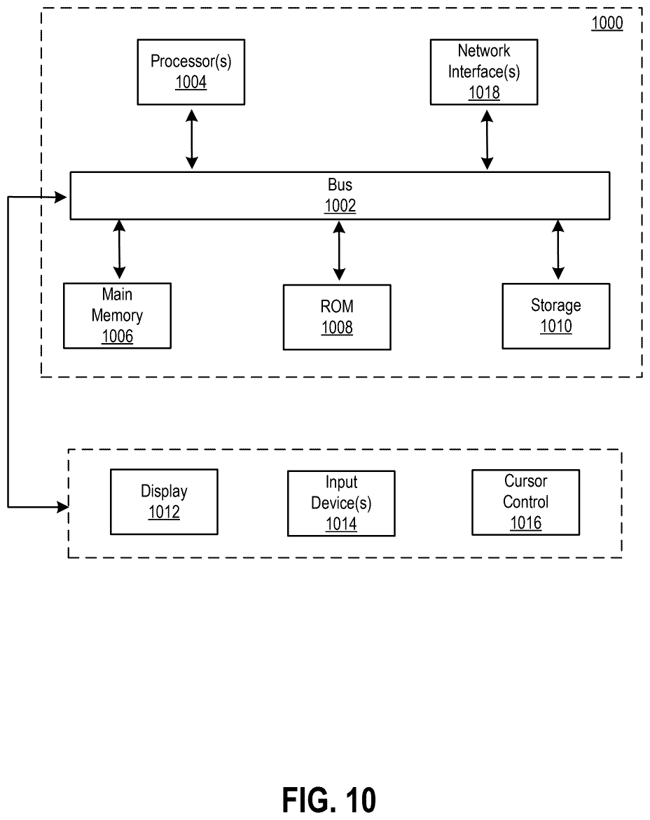

FIG. 10 depicts a block diagram of an example computer system 1000 in which various examples of the disclosed technology described herein may be implemented. The computer system 1000 includes a bus 1002 or other communication mechanism for communicating information, one or more hardware processors 1004 coupled with bus 1002 for processing information. Hardware processor(s) 1004 may be, for example, one or more general-purpose microprocessors. The computer system 1000 may be implemented as one or more components of the described in connection with FIGS. 1A, 1B, and 7.

The computer system 1000 also includes a main memory 1006, such as a random-access memory (RAM), cache, and/or other dynamic storage devices, coupled to bus 1002 for storing information and instructions to be executed by processor 1004. Main memory 1006 also may be used for storing temporary variables or other intermediate information during execution of instructions to be executed by processor 1004. Such instructions, when stored in storage media accessible to processor 1004, render computer system 1000 into a special-purpose machine that is customized to perform the operations specified in the instructions. For example, main memory 1006 may store instructions, that when executed by processor(s) 1004, cause computer system 1000 to perform one or more of the operations described in connection with FIGS. 3-7.

The computer system 1000 further includes a read only memory (ROM) 1008 or other static storage device coupled to bus 1002 for storing static information and instructions for processor 1004. A storage device 1010, such as a magnetic disk, optical disk, or USB thumb drive (Flash drive), etc., is provided and coupled to bus 1002 for storing information and instructions.

The computer system 1000 may be coupled via bus 1002 to a display 1012, such as a liquid crystal display (LCD) (or touch screen), for displaying information to a computer user. An input device 1014, including alphanumeric and other keys, is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. In some examples, the same direction information and command selections as cursor control may be implemented via receiving touches on a touch screen without a cursor.

The computing system 1000 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C, or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EEPROM. It will be further appreciated that hardware components may be comprised of connected logic units, such as gates and flip-flops, and/or may be comprised of programmable units, such as programmable gate arrays or processors.

The computer system 1000 may implement the techniques described herein using customized hard-wired logic, one or more ASICs or FPGAS, firmware and/or program logic which in combination with the computer system causes or programs computer system 1000 to be a special-purpose machine. According to one example of the disclosed technology, the techniques herein are performed by computer system 1000 in response to processor(s) 1004 executing one or more sequences of one or more instructions contained in main memory 1006. Such instructions may be read into main memory 1006 from another storage medium, such as storage device 1010. Execution of the sequences of instructions contained in main memory 1006 causes processor(s) 1004 to perform the process steps described herein. In alternative examples, hard-wired circuitry may be used in place of or in combination with software instructions.

The term “non-transitory media,” and similar terms as used herein, refers to any media that store data and/or instructions that cause a machine to operate in a specific fashion. Such non-transitory media may comprise non-volatile media and/or volatile media. Non-volatile media includes, for example, optical or magnetic disks, such as storage device 1010. Volatile media includes dynamic memory, such as main memory 1006. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EEPROM, a FLASH-EEPROM, NVRAM, any other memory chip or cartridge, and networked versions of the same.

Non-transitory media is distinct from, but may be used in conjunction with, transmission media. Transmission media participates in transferring information between non-transitory media. For example, transmission media includes coaxial cables, copper wire and fiber optics, including the wires that comprise bus 1002. Transmission media can also take the form of acoustic or light waves, such as those generated during radio-wave and infrared data communications.

The computer system 1000 also includes a network interface 1018 (also referred to as a communication interface) coupled to bus 1002. Network interface 1018 provides a two-way data communication coupling to one or more network links that are connected to one or more local networks. For example, network interface 1018 may be an integrated services digital network (ISDN) card, cable modem, satellite modem, or a modem to provide a data communication connection to a corresponding type of telephone line. As another example, network interface 1018 may be a local area network (LAN) card to provide a data communication connection to a compatible LAN (or WAN component to communicate with a WAN). Wireless links may also be implemented. In any such implementation, network interface 1018 sends and receives electrical, electromagnetic, or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the worldwide packet data communication network, now commonly referred to as the “Internet.” Local network and Internet both use electrical, electromagnetic, or optical signals that carry digital data streams. The signals through the various networks and the signals on network link and through network interface 1018, which carry the digital data to and from computer system 1000, are example forms of transmission media.

The computer system 1000 can send messages and receive data, including program code, through the network(s), network link and network interface 1018. In the Internet example, a server might transmit a requested code for an application program through the Internet, the ISP, the local network, and the network interface 1018.

The received code may be executed by processor 1004 as it is received, and/or stored in storage device 1010, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAS, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 1000.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A system comprising:
a communication channel;
a plurality of sensors communicably connected to the communication channel, the plurality of sensors configured to generate telemetry data of the system;
a scheduler circuit configured to activate the communication channel according to a system rate and sample the telemetry data generated by the plurality of sensors according to a plurality of data collection rate groups, wherein each of the data collection rate groups comprises a subset of the plurality of sensors associated with a distinct data collection rate, wherein the distinct data collection rates are ratios of the system rate selected such that inverses of the ratios are whole numbers; and
an integrated circuit configured to write the sampled telemetry data into a buffer, wherein performance of the system is adapted based on the sampled telemetry data.

2. The system of claim 1, wherein the distinct data collection rates associated with the plurality of data collection rate groups comprise a high-speed data collection rate, one or more intermediate-speed data collection rates, and a low-speed data collection rate.

3. The system of claim 2, wherein the low-speed data collection rate is 1 Hz, the high-speed data collection rate is 100 Hz, and an intermediate-speed data collection rate of the one or more intermediate-speed data collection rates is 10 Hz.

4. The system of claim 2, wherein the low-speed data collection rate is synchronized with the high-speed data collection rate and the one or more intermediate-speed data collection rates, and wherein the one or more intermediate-speed data collection rates are synchronized with the high-speed data collection rate.

5. The system of claim 2, wherein the scheduler circuit is further configured to:
cause the integrated circuit to sample a first data collection rate group of the plurality of data collection rate groups at the high-speed data collection rate, and
cause the integrated circuit to sample a second data collection rate group and the first data collection rate group of the plurality of data collection rate groups at the low-speed data collection rate.

6. The system of claim 1, wherein the scheduler circuit is further configured to:
signal a worker circuit associated with the communication channel to:
activate the communication channel according to a channel rate, wherein an inverse of a ratio of the channel rate with the system rate is a whole number, wherein the channel rate is synchronized with the distinct data collection rates; and
cause the integrated circuit to sample the telemetry data generated by the plurality of data collection rate groups at a respective distinct data collection rate,
wherein the worker circuit signals the scheduler circuit that the telemetry data has been sampled.

7. A method comprising:
activating a communication bus of a computing system according to a system rate, wherein the communication bus is communicably coupled to a plurality of sensors;
sampling telemetry data generated by the plurality of sensors according to a plurality of data collection rate groups, wherein each data of the collection rate groups comprises a subset of the plurality of sensors associated with a distinct data collection rate, wherein the distinct data collection rates are ratios of the system rate selected such that inverses of the ratios are whole numbers;
registering the sampled telemetry data into a buffer; and
adapting performance of the computing system based on the sampled telemetry data.

8. The method of claim 7, wherein the distinct data collection rates associated with the plurality of data collection rate groups comprise a high-speed data collection rate, one or more intermediate-speed data collection rates, and a low-speed data collection rate.

9. The method of claim 8, wherein the low-speed data collection rate is 1 Hz, the high-speed data collection rate is 100 Hz, and an intermediate-speed data collection rate of the one or more intermediate-speed data collection rates is 10 Hz.

10. The method of claim 8, wherein the low-speed data collection rate is synchronized with the high-speed data collection rate and the one or more intermediate-speed data collection rates, and wherein the one or more intermediate-speed data collection rates are synchronized with the high-speed data collection rate.

11. The method of claim 8, further comprising:
sampling a first data collection rate group of the plurality of data collection rate groups at the high-speed data collection rate; and
sampling a second data collection rate group and the first data collection rate group of the plurality of data collection rate groups at the low-speed data collection rate.

12. The method of claim 7, further comprising:
activating the communication bus according to a bus rate, wherein an inverse of a ratio of the bus rate with the system rate is a whole number, wherein the bus rate is synchronized with the distinct data collection rates; and
sampling the telemetry data generated by the plurality of data collection rate groups at a respective distinct data collection rate.

13. A system comprising:
a first communication bus communicably coupled to a first plurality of sensors configured to generate first telemetry data of the system;
a second communication bus communicably coupled to a second plurality of sensors configured to generate second telemetry data of the system;
a memory storing instructions; and
a processor communicably connected to the memory and configured to execute the instructions to:
activate the first communication bus and the second communication bus according to a system rate;
sample the first and second telemetry data generated by the first and second plurality of sensors according to a plurality of data collection rate groups, wherein each of the data collection rate groups comprises a first subset of the first plurality of sensors and a second subset of the second plurality of sensors associated with a data collection rate, wherein the data collection rates are ratios of the system rate selected such that inverses of the ratios are whole numbers; and
register the sampled telemetry data into a buffer; and
adapt performance of the system based on the sampled telemetry data.

14. The system of claim 13, wherein the data collection rates associated with the plurality of data collection rate groups comprise a high-speed data collection rate, one or more intermediate-speed data collection rates, and a low-speed data collection rate.

15. The system of claim 14, wherein the low-speed data collection rate is 1 Hz, the high-speed data collection rate is 100 Hz, and an intermediate-speed data collection rate of the one or more intermediate-speed data collection rates is 10 Hz.

16. The system of claim 14, wherein the low-speed data collection rate is synchronized with the high-speed data collection rate and the one or more intermediate-speed data collection rates, and wherein the one or more intermediate-speed data collection rate is synchronized with the high-speed data collection rate.

17. The system of claim 14, wherein the processor is further configured to execute the instructions to:
at the high-speed data collection rate associated with a first data collection rate group, sample a first subset of the first plurality of sensors corresponding to the first data collection rate group of the plurality of data collection rate groups, and
at the low-speed data collection rate associated with a second data collection rate group, sample a second subset of the second plurality of sensors corresponding to the second collection rate group of the plurality of data collection rate groups and the first subset of the first plurality of sensors corresponding to the first data collection rate group.

18. The system of claim 14, wherein the processor is further configured to execute the instructions to:
sample a first subset of a first data collection rate group of the plurality of data collection rate groups at the high-speed data collection rate, and
sample a first subset of a first data collection rate group, a second data collection rate group, and the first data collection rate group of the plurality of data collection rate groups at the low-speed data collection rate.

19. The system of claim 13, wherein the processor is further configured to execute the instructions to:
signal a first worker circuit associated with the first communication bus to:
activate the first communication bus according to a first bus rate, wherein an inverse of a ratio of the first bus rate with the system rate is a whole number, wherein the first bus rate is synchronized with the distinct data collection rates; and
sample the first telemetry data generated by the plurality of data collection rate groups at a respective distinct data collection rate.

20. The system of claim 19, wherein the processor is further configured to execute the instructions to:
signal a second worker circuit associated with the second communication bus to:
activate the second communication bus according to a second bus rate, wherein an inverse of a ratio of the second bus rate with the system rate is a whole number, wherein the second bus rate is synchronized with the distinct data collection rates; and
sample the second telemetry data generated by the plurality of data collection rate groups at a respective distinct data collection rate.
